(19) United States
(12) Patent Application Publication
(10) Pub. No.: US 2026/0017615 A1
(43) Pub. Date: Jan. 15, 2026

(54) SATISFACTION SURVEY SYSTEMS AND METHODS

(71) Applicant: AMAZING WORKPLACE, INC., Bend, OR (US)

(72) Inventor: Shon Holyfield, Clearwater, FL (US)

(21) Appl. No.: 19/179,578

(22) Filed: Apr. 15, 2025

Related U.S. Application Data
(60) Provisional application No. 63/634,294, filed on Apr. 15, 2024.

(51) Int. Cl. G06Q 10/105

(52) U.S. Cl. CPC G06Q 10/105

(57) ABSTRACT

The present disclosure is directed to satisfaction surveys for measuring the presence of positive emotions and experiences, the absence of negative emotions and experiences, and identifies when users are getting what they need or want. More significantly, the survey gathers real-time data based on participant responses. Then, and before the survey ends, the system presents each participant with a happiness feeling that represents how it appears they feel (based on their unique responses to the Happiness Survey, for example). Survey participants are then asked if that is how they often feel, and if not, they may simply select a happiness feeling that matches how they actually feel. The result is a verified feeling.

### CLAIM OF PRIORITY

The present Application for Patent claims priority to U.S. Provisional Application No. 63/634,294 entitled “Employee Happiness Management Systems and Methods”, filed Apr. 15, 2024, which is hereby expressly incorporated by reference.

### TECHNICAL FIELD

The technology discussed below relates to employee happiness management systems (EHMS), and more specifically to digital satisfaction surveys for measuring the presence of positive emotions and experiences, the absence of negative emotions and experiences, and identifying when employees are getting what they need or want.

### BACKGROUND

Employee surveys are a powerful tool for understanding and enhancing workplace satisfaction. They provide a structured avenue for employees to share their thoughts, concerns, and levels of contentment, offering invaluable insights into the factors that contribute to a positive work environment. By systematically gathering this feedback, organizations can identify specific areas—such as communication, workload, or company culture—that may require attention or improvement.

The act of soliciting employee input through surveys demonstrates a company's commitment to valuing its workforce, which can, in turn, boost employee engagement and foster a sense of belonging. Addressing the issues highlighted in survey responses proactively can lead to reduced turnover rates, as employees feel heard and supported. Moreover, a satisfied workforce is often more productive and motivated, directly impacting the organization's overall performance.

Regularly conducting these surveys allows for the monitoring of changes in employee sentiment over time, enabling management to track the effectiveness of implemented strategies and interventions. The data collected serves as a foundation for informed decision-making, guiding adjustments in policies, benefits, and managerial practices aimed at enhancing employee satisfaction. In essence, employee surveys offer a systematic approach to understanding workforce happiness, acting as a catalyst for positive organizational change.

In summary, surveys provide a systematic approach to understanding and improving employee satisfaction, supporting both organizational growth and workforce well-being.

### SUMMARY

The following presents a simplified summary of one or more implementations in order to provide a basic understanding of some implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

According to one example, a computing system for collecting, verifying, and reporting data from survey participants is provided. The computing system comprises one or more participant devices, a server, and an administrator interface. Each of the one or more participant devices is configured to present a digital survey comprising a plurality of questions related to a topic of interest; receive one or more responses from a user, including selected answers and optionally written comments; and display a proposed emotional sentiment based on the one or more responses of the user and prompt the user to confirm or revise the proposed emotional sentiment. The server comprises one or more processors and memory for storing instructions that, when executed, cause the server to: receive and store the one or more responses from the one or more participant devices; analyze the one or more responses to generate an inferred emotional sentiment for each user; record a verified emotional sentiment based on user confirmation or correction of the inferred emotional sentiment; associate written comments with the verified emotional sentiment; and aggregate the verified data for presentation in one or more reporting interfaces. The administrator interface is configured to display aggregated emotional sentiment data and comment summaries for one or more workplace groups; allow filtering of the aggregated emotional sentiment data based on one or more parameters including topic, department, location, or employee demographics; and display visualizations showing sentiment distribution, group comparisons, and user-submitted commentary linked to aggregated emotional sentiment data.

According to one aspect, the memory is a non-transitory computer-readable storage medium; and wherein the instructions stored on the non-transitory computer-readable storage medium further cause the server to present, to the each user, a confirmation prompt asking whether the inferred emotional sentiment accurately reflects how the user feels.

According to another aspect, the server is further configured to update the verified emotional sentiment based on a user-selected correction to the proposed emotional sentiment.

According to yet another aspect, each written comment in the comment summaries submitted by the user is tagged with a label corresponding to the verified emotional sentiment of the user at a time the comment was submitted.

According to yet another aspect, the administrator interface is further configured to display a distribution of emotional sentiment values across a plurality of workplace groups in a comparative format.

According to yet another aspect, the administrator interface is configured to filter sentiment results by at least one of a survey topic, a department, a location, an employee role, and a demographic attribute.

According to yet another aspect, the administrator interface further displays employee comments in a format grouped by associated emotional sentiment.

According to yet another aspect, the server is configured to track and display changes in emotional sentiment over time for individual users or defined workplace groups.

According to another example, a method for collecting, verifying, and reporting emotional sentiment data from survey participants is provided. The method comprises presenting, via one or more participant devices, a digital survey comprising a plurality of questions related to a topic of interest; receiving, from a user, one or more responses to the digital survey, including selected answers and optionally written comments; analyzing the one or more responses to generate an inferred emotional sentiment for the user; presenting the inferred emotional sentiment to the user and prompting the user to confirm or revise the inferred emotional sentiment; receiving, from the user, a verified emotional sentiment; associating the verified emotional sentiment with the one or more responses and any written comments; storing the verified emotional sentiment in association with a survey record of the user; and displaying, via an administrator interface, one or more visualizations of aggregated emotional sentiment data and associated commentary for individual users or workplace groups.

According to one aspect, the method further comprises presenting a confirmation prompt to the user asking whether the inferred emotional sentiment accurately reflects how the user feels.

According to another aspect, the method further comprises updating the verified emotional sentiment based on a user selection to revise the inferred emotional sentiment; tagging each written comment submitted by the user with a label corresponding to the verified emotional sentiment; and filtering the aggregated emotional sentiment data based on at least one of a survey topic, a department, a location, an employee role, and a demographic attribute.

According to yet another aspect, the one or more visualizations comprise a distribution of emotional sentiment values across a plurality of workplace groups.

According to yet another aspect, the method further comprises grouping and displaying user-submitted comments according to the associated verified emotional sentiment; and tracking changes in the associated verified emotional sentiment over time for individual users or predefined organizational groups.

According to yet another example, a non-transitory computer-readable storage medium storing instructions that, when executed by one or more processors, cause a computing system to perform a method for collecting, verifying, and reporting emotional sentiment data is provided. The method comprises presenting a digital survey to a user via a participant device, the digital survey comprising a plurality of questions related to a topic of interest; receiving one or more survey responses from the user, including selected answers and optionally written comments; analyzing the responses to generate an inferred emotional sentiment; prompting the user to confirm or revise the inferred emotional sentiment; recording a verified emotional sentiment based on input from the user; associating the verified emotional sentiment with the one or more survey responses and any written comments; aggregating the verified emotional sentiment data from multiple users; and generating one or more visualizations of the aggregated verified emotional sentiment data for presentation through an administrator interface.

According to one aspect, the instructions further cause the computing system to present a confirmation prompt asking the user to verify whether the inferred emotional sentiment accurately reflects how the user feels.

According to another aspect, the instructions further cause the computing system to receive a revised emotional sentiment from the user and store the revised emotional sentiment as a verified emotional sentiment.

According to yet another aspect, the instructions further cause the computing system to associate a label with each written comment submitted by the user, the label corresponding to the verified emotional sentiment.

According to yet another aspect, the instructions further cause the computing system to filter the aggregated verified sentiment data based on at least one of: a topic, a department, an organizational unit, a location, and an employee demographic attribute.

According to yet another aspect, the instructions further cause the computing system to generate a visualization comprising a distribution of emotional sentiment values across multiple workplace groups.

According to yet another aspect, the instructions further cause the computing system to display user comments grouped by their associated verified emotional sentiment; and track and display changes in verified emotional sentiment over time for individual users or defined organizational groups.

### BRIEF DESCRIPTION OF THE DRAWINGS

FIG. 1 illustrates a prior art process for conducting a typical employee satisfaction survey.

FIG. 2 illustrates a block diagram of an environment in which a digital survey system can operate in accordance with one or more aspects of the present disclosure.

FIG. 3 illustrates a block diagram of an example hardware implementation of a survey participant device configured to communicate according to one or more aspects of the disclosure.

FIG. 4 illustrates a block diagram of an example hardware implementation of an administrator device configured to communicate according to one or more aspects of the present disclosure.

FIG. 5 illustrates a flow diagram of a method for generating and displaying a happiness indicator based on user responses to a digital survey, in accordance with one or more aspects of the present disclosure.

FIG. 6 illustrates an example graphical user interface (GUI) representing a first screen in a happiness conversation sequence, in accordance with one or more aspects of the present disclosure.

FIG. 7 illustrates an example graphical user interface (GUI) representing a subsequent step in a topic-based happiness conversation, in accordance with one or more aspects of the present disclosure.

FIG. 8 illustrates an example graphical user interface (GUI) representing a follow-up screen in a topic-based happiness conversation, in accordance with one or more aspects of the present disclosure.

FIG. 9 illustrates an example graphical user interface (GUI) representing a follow-up screen in a topic-based happiness conversation, in accordance with one or more aspects of the present disclosure.

FIG. 10 illustrates an example graphical user interface (GUI) presented during a topic-based happiness conversation, in accordance with one or more aspects of the present disclosure.

FIG. 11 illustrates an example graphical user interface (GUI) representing a continuation of a topic-based happiness conversation, in accordance with one or more aspects of the present disclosure.

FIG. 12 illustrates an example graphical user interface (GUI) configured to present a happiness verification screen, in accordance with one or more aspects of the present disclosure.

FIG. 13 illustrates an example graphical user interface (GUI) configured to facilitate user correction of an inferred emotional sentiment, in accordance with one or more aspects of the present disclosure. This screen follows the verification interface shown in FIG. 12, where the system suggested that the user often feels happy at work.

FIG. 14 illustrates an example graphical user interface (GUI) configured to present a happiness conversations report, in accordance with one or more aspects of the present disclosure.

FIG. 15 illustrates an example graphical user interface (GUI) representing a continuation of the happiness conversations report, in accordance with one or more aspects of the present disclosure.

FIG. 16 illustrates an example graphical user interface (GUI) configured to display the enhanced level of accuracy that the happiness verification has provided this conversation, in accordance with one or more aspects of the present disclosure.

FIG. 17 illustrates an example graphical user interface (GUI) configured to facilitate administrative workflows related to employee sentiment data management, in accordance with one or more aspects of the present disclosure.

FIG. 18 illustrates an example graphical user interface (GUI) representing an alternative or supplemental welcome screen for returning users, in accordance with one or more aspects of the present disclosure.

FIG. 19 illustrates an example graphical user interface (GUI) configured to display a list-based view of employee survey responses, in accordance with one or more aspects of the present disclosure.

FIG. 20 illustrates an example graphical user interface (GUI) configured to enable a user to select a background image or theme for personalization of the survey or reporting environment, in accordance with one or more aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. As used herein, a reference to an element in the singular contemplates the reference to the element in the plural.

Although the present disclosure is described primarily in the context of surveys designed to assess employee happiness and emotional well-being within workplace environments, the underlying systems, methods, and technologies are not limited to such use cases. The principles and components of the disclosure, such as emotion verification, comment association, and structured sentiment reporting, are broadly applicable and may be adapted for use in a wide variety of survey-based applications.

For example, the disclosed technology may be utilized in satisfaction surveys across diverse domains, including but not limited to customer satisfaction, student engagement, patient feedback, organizational climate assessments, and consumer product reviews. The emotion verification and data visualization techniques described herein may be applied to any scenario where it is valuable to understand not only what a respondent says but also how they feel, and to capture verified emotional responses alongside structured or open-ended feedback.

Accordingly, the present disclosure should be understood as encompassing any implementation in which survey data is collected, emotional responses are inferred and verified, and results are presented in a manner that supports deeper insight and action. These adaptations are within the scope and spirit of the present disclosure.

### Overview

The present disclosure is directed to satisfaction surveys for measuring the presence of positive emotions and experiences, the absence of negative emotions and experiences, and identifies when users are getting what they need or want. More significantly, the survey gathers real-time data based on participant responses. Then, and before the survey ends, the system presents each participant with a happiness feeling that represents how it appears they feel (based on their unique responses to the Happiness Survey, for example). Survey participants are then asked if that is how they often feel, and if not, they may simply select a happiness feeling that matches how they actually feel. The result is a verified feeling.

The systems and methods of the present disclosure comprise integrated software technologies that work together to collect, analyze, verify, and present emotional sentiment data from survey participants in a structured and actionable format. For example, the systems and methods of the present disclosure comprise six (6) technologies. These technologies include (1) Survey Technology: Software that delivers survey questions to participants, records their responses, and stores the collected data. This information is subsequently used to generate sentiment and feedback reports for the organization that initiated the survey; (2) Happiness Measurement Technology (Happiness Verification Technology) Software Description: This technology analyzes a range of survey participant data, including selected responses, written comments, and response timing, to infer how the participant likely feels. The system then asks the participant to either confirm or revise the inferred emotional state. The verified emotional response (i.e., verified emotional sentiment data based on user confirmation or correction of the inferred emotional sentiment) is captured and stored as part of the participant's final survey record; (3) Survey Results Technology: Software that processes the data collected via the Survey Technology (see Survey Technology above) and provides intuitive, interactive user interfaces that enable quick yet comprehensive understanding of participant responses, sentiment trends, and key insights; (4) Happiness Verification Results Technology: Software that visualizes the results of the Happiness Measurement Technology (see Happiness Measurement Technology above). It presents metrics showing how many participants: Confirmed their initial emotional state, changed their emotional state, became happier, and became less happy; (5) Comment Sentiment Mapping Technology: Software that displays employee comments, categorized and presented in relation to the verified emotional state (based on user confirmation or correction of the inferred emotional sentiment) selected by each participant. This allows organizations to understand how someone felt at the time they submitted their comment—providing context and emotional clarity that enhances interpretation of open-ended feedback; and (6) User Interface System (System Layout & Design): A comprehensive user interface framework that integrates all of the above technologies into a single, cohesive platform. The system includes intuitive navigation, visual design elements, and modular components (e.g., buttons, tabs, filters) that make the platform easy to use for both administrators and participants.

Although six (6) technologies are shown, this is by way of example only and there may be more than six (6) technologies or less than (6) technologies

### Terms

The terms “participant device” and “administrator device module” could embody or be implemented within a server, a personal computer, a mobile phone, a smart phone, a tablet, a portable computer, a machine, an entertainment device, or any other electronic device having circuitry.

The terms “participant devices” and “survey participant devices” may be used interchangeably.

The terms “user(s)”, “individual user(s)”, and “participant” may be used interchangeably.

The terms “user interface” and “user interface module” could embody or be implemented within a server, a personal computer, a mobile phone, a smart phone, a tablet, a portable computer, a machine, an entertainment device, or any other electronic device having circuitry.

The term “user interface” may refer to the participant device.

The term “administrator interface”, as used herein, refers to a graphical user interface (GUI), web-based dashboard, or other software-based control panel that is accessible by an authorized user (e.g., a system administrator, manager, or analyst) and configured to facilitate interaction with the underlying survey system. The administrator interface may enable the user to perform various functions including, but not limited to, creating and configuring survey questions, deploying surveys to participant devices, viewing and filtering collected response data, reviewing verified emotional sentiment data (based on user confirmation or correction of the inferred emotional sentiment), accessing employee comments, generating reports, monitoring participation metrics, and managing access permissions. The administrator interface may be rendered on any computing system, including a desktop, laptop, tablet, or web-enabled device, and may be customized based on user roles or organizational hierarchy.

The terms “selectable emotional response” and “selected answers” may be used interchangeably.

The term “demographic attribute”, as used herein, refers to any characteristic or classification associated with an individual that may be used to group, segment, filter, or analyze data across a population. In the context of employee sentiment systems, demographic attributes may include, but are not limited to, age, gender, race or ethnicity, job title, department, geographic location, tenure, education level, employment type (e.g., full-time, part-time, contractor), or any other attribute relevant to organizational structure or employee identity. Demographic attributes may be obtained from human resource databases, user input, or system-generated metadata, and may be used for comparative reporting, trend analysis, or targeted engagement strategies, subject to applicable privacy and data protection regulations.

The term “employer” may refer to any individual, entity, organization, institution, or enterprise that engages or oversees the work of one or more employees, contractors, or affiliated personnel, including but not limited to corporations, non-profits, government agencies, academic institutions, and small businesses.

The term “employee” may refer to any individual engaged in work or services for an organization, including full-time or part-time workers, contractors, freelancers, interns, volunteers, or other affiliated personnel, regardless of employment classification or geographic location.

The term “emotional sentiment data”, as used herein, refers to information that reflects or represents an individual's emotional state, feeling, or mood in relation to a specific topic, question, or context within a digital survey. Emotional sentiment data may include, but is not limited to, user-selected emotional indicators (e.g., “happy,” “unhappy,” “very happy”), inferred emotional classifications derived from analysis of responses or behavioral patterns, and verified emotional responses (i.e., verified emotional sentiment data based on user confirmation or correction of the inferred emotional sentiment) confirmed or corrected by the user. Emotional sentiment data may further be associated with response timing, open-text comments (i.e. optionally written comments), topic identifiers, or demographic metadata, and may be used to generate individual or aggregated emotional insights for reporting, visualization, or decision-making purposes.

The term “workplace group”, as used herein, refers to any defined subset of individuals within an organization who share a common attribute or organizational affiliation. A workplace group may be based on, but is not limited to, department, team, business unit, job role, geographic location, reporting structure, or demographic characteristic. Workplace groups may be predefined by the organization or dynamically generated by the system based on metadata associated with survey participants. Emotional sentiment data and survey results may be aggregated, filtered, or compared across one or more workplace groups for the purpose of generating targeted insights, visualizations, or reports.

The term “linked”, as used herein, refers to a structured association between two or more data elements within the system. In particular, user-submitted commentary is considered “linked” to emotional sentiment data when the system maintains a defined relationship between the comment and the corresponding emotional state selected, inferred, or verified for the user. This linkage may be established through a shared data identifier, time-based correlation, metadata tagging, or storage within a common data structure or database record. The linkage ensures that the emotional context in which a comment was provided is preserved and accessible, allowing for accurate grouping, filtering, display, or analysis of the commentary in conjunction with verified emotional sentiment.

The term “employee demographics” refers to descriptive attributes or classification data associated with an individual employee, which may be used to segment, filter, or analyze survey responses or emotional sentiment data. Employee demographics may include, but are not limited to, age, gender, job title, department, tenure, employment type (e.g., full-time, part-time, contractor), geographic location, office or region, education level, or other role-based or identity-related information as permitted by organizational policy and applicable privacy regulations. Demographic data may be user-supplied, system-generated, or imported from human resource information systems (HRIS), and may be used in connection with reporting, comparative analysis, or targeted engagement strategies.

The term “comparative format” refers to a visual or data presentation structure that enables the evaluation, contrast, or ranking of two or more data sets, categories, or groups in relation to one another. In the context of emotional sentiment analysis, a comparative format may include, but is not limited to, side-by-side charts, tables, graphs, heat maps, score differentials, percentage comparisons, or other visualizations that show how sentiment values or participation metrics for one workplace group compare to those of other groups or to an overall organizational baseline. A comparative format may also support dynamic filtering, sorting, or highlighting to facilitate interpretation of performance gaps, trends, or outliers across groups.

The phrase “display visualizations showing sentiment distribution” refers to the presentation of graphical or visual output that represents how emotional sentiment values, such as “very happy,” “happy,” “neutral,” or “unhappy”, are spread across a set of participants, workplace groups, or demographic segments. These visualizations may include, but are not limited to, pie charts, bar graphs, heat maps, stacked columns, trend lines, or other graphical formats that depict the relative frequency, proportion, or trend of each sentiment category. The purpose of such visualizations is to enable quick comprehension of emotional patterns within the organization, identify sentiment disparities, and support data-driven decision-making.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, Non-Volatile Random Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a Random Access Memory (RAM), a Programmable Read-Only Memory (PROM), and Erasable Programmable Read-Only Memory (EPROM), a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “central processing unit”, “processor”, “processor circuit”, and “processing circuit”, and variations thereof, as used herein, are used interchangeably and include, but are not limited to, a general purpose processor, a digital signal processor (DSP), an application-specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processor may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processors are for illustration and other suitable configurations within the scope of the disclosure are also contemplated. Furthermore, the processor may be implemented as one or more processors, one or more controllers, and/or other structure configured to execute executable programming.

The term “computing system”, as used herein, refers to one or more physical or virtual computing devices that include at least one processor and at least one non-transitory computer-readable storage medium storing instructions executable by the processor. A computing system may include, but is not limited to, a server, a client device, a desktop computer, a laptop, a tablet, a smartphone, a virtual machine, or any combination thereof. The computing system may operate as a standalone device or be distributed across multiple devices that communicate over one or more networks. In certain embodiments, the computing system may implement or host components of the survey system described herein, such as survey delivery, emotional sentiment analysis, verification logic, or data reporting functionality.

The term “module” as used herein refers to any known or later developed hardware, software, firmware, artificial intelligence, fuzzy logic, or combination of hardware and software that is capable of performing the functionality associated with that element.

“Comprise” and variations, such as “comprising” and “comprises,” are not intended to exclude other additives, components, integers or steps. “A”,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, “embodiments” does not require that all embodiments include the discussed feature, advantage or mode of operation.

“Aspects” do not require that all aspects of the disclosure include the discussed features, advantages, or modes of operation. “Coupled” is used herein to means the direct or indirect coupling between two objects. For example, if object A physically touches or couples to object B, and object B touches or couples to object C, then objects A and C may still be considered coupled to one another, even if they do not directly physically touch each other.

### Typical Satisfaction Survey

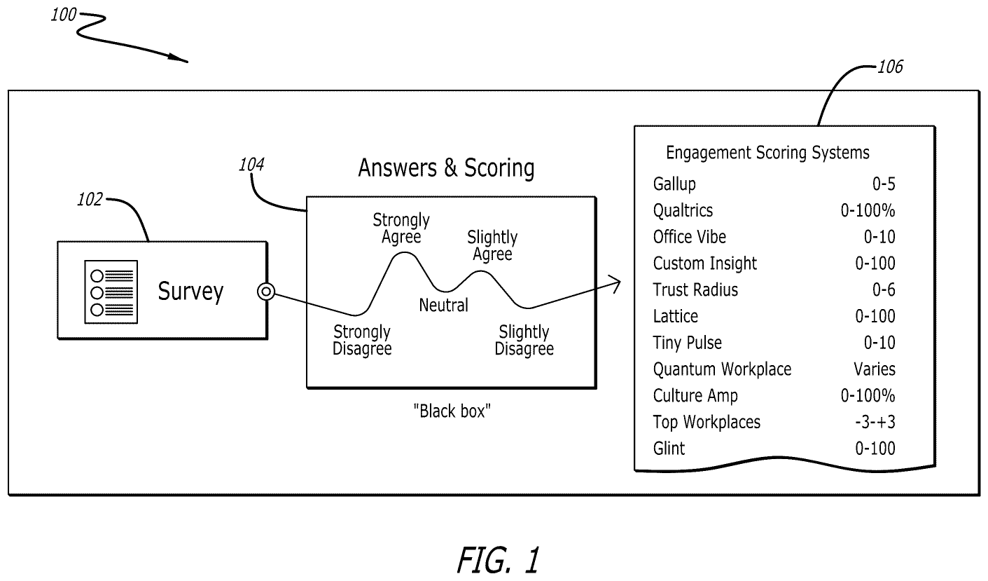

FIG. 1 illustrates a prior art process 100 for conducting a typical employee satisfaction survey. As shown, the process begins with the design of a survey 102 by management or human resources personnel, wherein a set of questions is formulated to assess various aspects of employee experience, including but not limited to engagement, communication, workload, and organizational culture. The survey is then distributed to employees through digital platforms or printed media.

Upon receipt, employees participate in the survey by providing responses to the questions presented 104. The survey may include multiple-choice, Likert-scale, and open-ended formats. Employee responses are then collected and aggregated 106, typically in a centralized system for data management. The collected data is analyzed to identify response trends, critical issues, and opportunities for organizational improvement.

The analyzed data is reviewed by decision-makers, such as management or HR personnel, who assess the findings to determine necessary interventions. Based on the results, action plans are developed to address identified concerns or improve workplace conditions. Management may also communicate the results and proposed actions to employees, thereby promoting transparency and reinforcing a feedback-driven culture.

Following communication, changes or improvements are implemented based on the action plans. The process may include ongoing monitoring through follow-up surveys or assessments to measure the effectiveness of the implemented changes and to ensure continuous improvement in employee satisfaction over time.

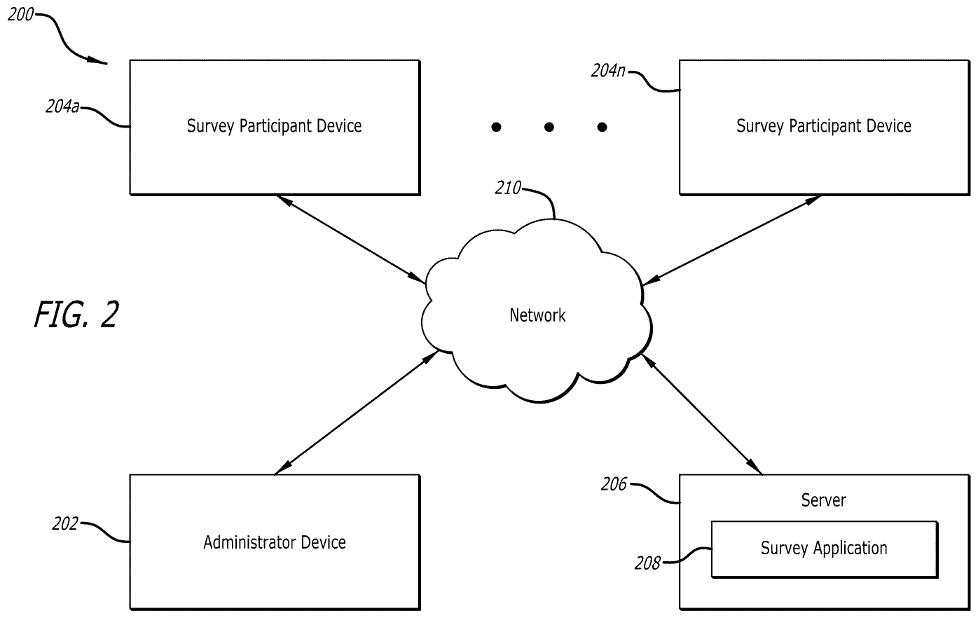

FIG. 2 illustrates a block diagram of an environment 200 in which a digital survey system can operate in accordance with one or more aspects of the present disclosure. As shown, the environment 200 includes an administrator device 202, a plurality of participant devices 204a-204n, and a server 206. The server 206 hosts a survey application 208 configured to manage the creation, distribution, and analysis of digital surveys as well as track changes in emotion sentiment over time for individual users or defined workplace groups. Communication among the administrator device 202, the participant devices 204a-204n, and the server 206 is facilitated via one or more wired and/or wireless communication networks 210, which may include, but are not limited to, a public switched telephone network (PSTN), wide area network (WAN), local area network (LAN), the Internet (e.g., a Transmission Control Protocol/Internet Protocol (TCP/IP) network), and wireless communication protocols such as 3G, 4G, Long Term Evolution (LTE), and 5G networks. The network(s) 210 may comprise any one or a combination of these types.

The survey system may be implemented on one or more physical or virtual servers or cloud-based platforms configured to perform various survey-related operations, including survey content creation, distribution, data collection, response aggregation, sentiment analysis, and result reporting, as well as track changes in emotion sentiment over time for individual users or defined workplace groups. The system may further include or interface with one or more databases for storing survey content (including a user's survey record), user responses, participant profiles, historical emotional sentiment data, and metadata associated with survey activity.

The participant devices 204a-204n serve as endpoints through which users (e.g., employees or other participants) interact with the survey system. These devices may include, without limitation, desktop computers, laptops, smartphones, tablets, or other network-connected computing devices equipped with a user interface. Through these devices, participants can receive survey prompts, submit responses, and optionally view summary results or feedback generated by the system.

The participant devices are configured to present surveys and capture real-time responses. Based on the data submitted by the participant and prior to survey completion, the system may generate and display an inferred emotional state, such as a representation of the user's perceived happiness level, determined through algorithmic analysis of responses, written input, and timing data.

The administrator device 202 is used to manage all aspects of the survey life cycle, including configuring questions, defining logic rules, setting deployment parameters, and initiating survey distribution to participant devices across the communication network(s) 210. The administrator device may also be used to monitor participation, access results, and generate reports.

In some aspects, the digital survey system may employ real-time or batch analytics engines to process collected data and generate insights for organizational decision-making. Access to the system's functionality may be role-based, requiring authentication and access control measures aligned with an organization's privacy, data governance, and hierarchy protocols.

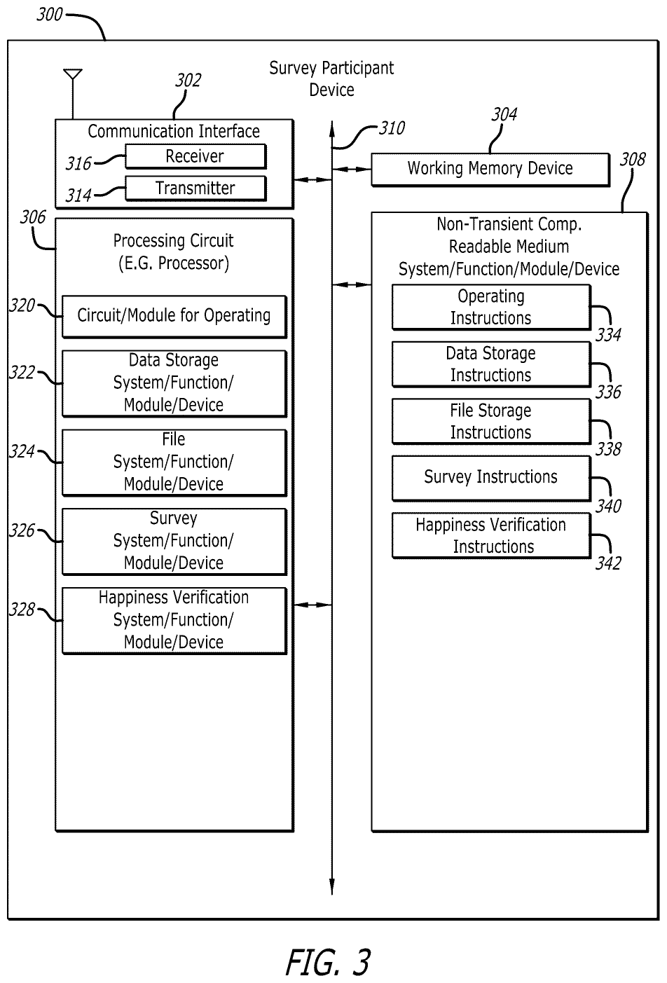

FIG. 3 illustrates a block diagram of an example hardware implementation of a survey participant device 300 configured to communicate according to one or more aspects of the disclosure. The survey participant device 300 may include, for example, a communication interface 302. The communication interface 302 may enable data and control input and output. The communication interface 302 may, for example, enable communication over one or more communication networks, similar to communication network(s) 210 of FIG. 2. The communication interface 302 may be communicatively coupled, directly or indirectly, to the communication network(s) 210. The survey participant device 300 may include a local working memory device 304, and a processor system/function/module/device (hereinafter the processor 306). The processor 306 may use the working memory device 304 to store data that is about to be operated on, being operated on, or was recently operated on. The processor 306 may store instructions on the working memory device 304 (e.g., memory storing instructions) and/or on one or more other memory structures or devices, such as, for example, non-transient computer readable medium system/function/module/device (hereinafter the non-transient computer readable medium 308). When executed by the processor 306, the instructions may cause the processor 306 to perform, for example, one or more aspects of the methods described herein.

The survey participant device 300 may be implemented with a bus architecture, represented generally by the bus 310. The bus 310 may include any number of interconnecting buses and bridges depending on the specific application of the survey participant device 300 and overall design constraints. The bus 310 may communicatively couple various circuits including one or more processors (represented generally by the processor 306), the working memory device 304, the communication interface 302, and the non-transient computer readable medium 308. The bus 310 may also link various other circuits and devices, such as timing sources, peripherals, voltage regulators, and power management circuits and devices, which are well known in the art, and therefore, are not described any further.

The communication interface 302 provides a means for communicating with other apparatuses over a transmission medium. In some implementations, the communication interface 302 includes circuitry and/or programming adapted to facilitate the communication of information bi-directionally with respect to one or more communication devices in a network. In some implementations, the communication interface 302 is adapted to facilitate wireless communication of the survey participant device 300. In these implementations, the communication interface 302 may be coupled to one or more antennas 312 as shown in FIG. 3 for wireless communication within a wireless communication system. In some implementations, the communication interface 302 may be configured for wire-based communication. For example, the communication interface 302 could be a bus interface, a send/receive interface, or some other type of signal interface including drivers, buffers, or other circuitry for outputting and/or obtaining signals (e.g., outputting signal from and/or receiving signals into an integrated circuit). The communication interface 302 can be configured with one or more standalone receivers and/or transmitters, as well as one or more transceivers. In the illustrated example, the communication interface 302 includes a transmitter 314 and a receiver 316. The communication interface 302 serves as one example of a means for receiving and/or means transmitting.

The processor 306 may be responsible for managing the bus 310 and general processing, including the execution of software stored on the non-transient computer readable medium 308. The software, when executed by the processor 306, may cause the processor 306 to perform the various functions described below for any particular apparatus or module. The non-transient computer readable medium 308 and the working memory device 304 may also be used for storing data that is manipulated by the processor 306 when executing software.

One or more processors, such as processor 306 in the survey participant device 300 may execute software. Software may be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transient computer readable medium, such as non-transient computer readable medium 308. Non-transient computer readable medium 308 may include, by way of example, a magnetic storage device (e.g., hard disk, floppy disk, magnetic tape, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable non-transient medium for storing software, date, and/or instructions that may be accessed and read by a computer or the processor 306. Computer readable media may also include, by way of example, a carrier wave, a transmission line, and any other suitable medium for transmitting software and/or instructions that may be accessed and read by a computer or the processor 306. The non-transient computer readable medium 308 may reside in the survey participant device 300, external to the survey participant device 300, or distributed across multiple entities including the survey participant device 300.

The processor 306 is arranged to obtain, process and/or send data, control data access and storage, issue commands, and control other desired operations. The processor 306 may include circuitry configured to implement desired programming provided by appropriate media in at least one example.

The non-transient computer readable medium 308 may be embodied in a computer program product. By way of example, a computer program product may include a computer readable medium in packaging materials. Those skilled in the art will recognize how best to implement the described functionality presented throughout this disclosure depending on the particular application and the overall design constraints imposed on the overall system.

In some aspects of the disclosure, the processor 306 may include circuitry configured for various functions. For example, the processor 306 may include a circuit/module for operating 320 and configured to manage the survey and to perform input/output operations associated with access to the Internet web and perform, for example, methods described herein. For example, the processor 306 may include a data storage 322 system/function/module/device configured to store data including but not limited to responses to the survey. For example, the processor 306 may include a file system/function/module/device 324 configured to control how data in local data storage and/or remote data storage is stored and retrieved. For example, the processor 306 may include a survey system/function/module/device 326 configured to present survey questions to a participant and collect the responses to the survey questions. For example, the processor 306 may include a happiness verification system/function/module/device 328 configured to present to the participant an estimation of how the participant feels, based on the responses to the survey questions.

In some aspects of the disclosure, the non-transient computer readable medium 308 of the survey participant device 300 may include instructions that may cause the various systems/functions/modules/devices of the processor 306 to perform the methods described herein. For example, the non-transient computer readable medium 308 may include operating instructions or code 320 to the circuit/module for operating 320. For example, the non-transient computer readable medium 308 may include data storage instructions 336 corresponding to the data storage system/function/module/device 322. For example, the non-transient computer readable medium 308 may include file system instructions 338 corresponding to the file system/function/module/device 324. For example, the non-transient computer readable medium 308 may include survey instructions 340 corresponding to the survey system/function/module/device 326. For example, the non-transient computer readable medium 308 may include happiness verification instructions 342 corresponding to the happiness verification system/function/module/device 328.

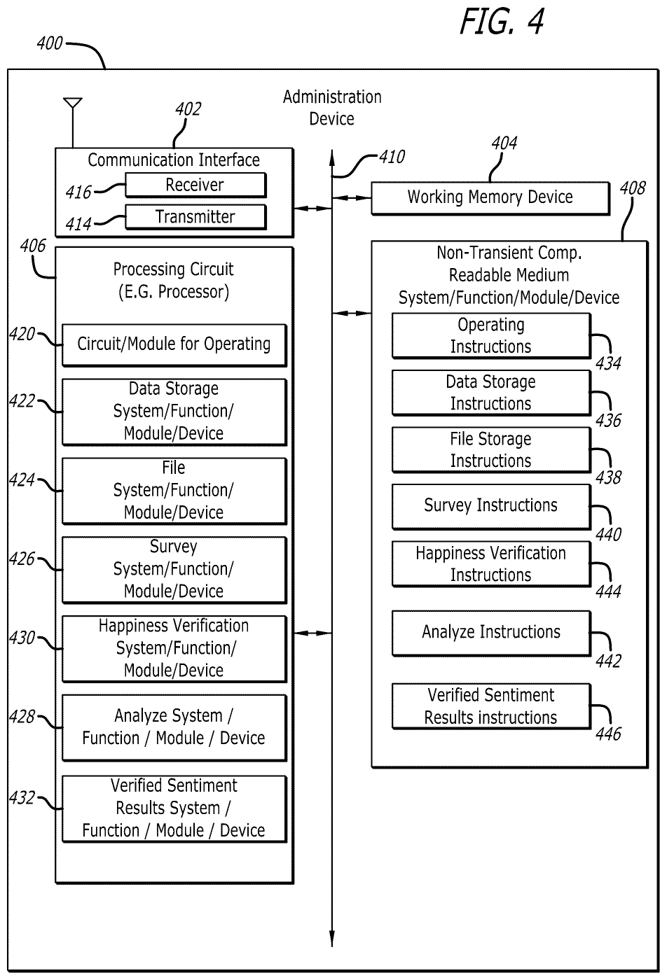

FIG. 4 illustrates a block diagram of an example hardware implementation of an administrator device 400 configured to communicate according to one or more aspects of the disclosure. The administrator device 400 may include, for example, a communication interface 402. The communication interface 402 may enable data and control input and output. The communication interface 402 may, for example, enable communication over one or more communication networks, similar to communication network(s) 210 of FIG. 2. The communication interface 402 may be communicatively coupled, directly or indirectly, to the communication network(s) 210. The administrator device 400 may include a local working memory device 404, and a processor system/function/module/device (hereinafter the processor 406). The processor 406 may use the working memory device 404 to store data that is about to be operated on, being operated on, or was recently operated on. The processor 406 may store instructions on the working memory device 404 and/or on one or more other memory structures or devices, such as, for example, non-transient computer readable medium system/function/module/device (hereinafter the non-transient computer readable medium 408). When executed by the processor 406, the instructions may cause the processor 406 to perform, for example, one or more aspects of the methods described herein.

The administrator device 400 may be implemented with a bus architecture, represented generally by the bus 410. The bus 410 may include any number of interconnecting buses and bridges depending on the specific application of the survey participant device 400 and overall design constraints. The bus 410 may communicatively couple various circuits including one or more processors (represented generally by the processor 406), the working memory device 404, the communication interface 402, and the non-transient computer readable medium 408. The bus 410 may also link various other circuits and devices, such as timing sources, peripherals, voltage regulators, and power management circuits and devices, which are well known in the art, and therefore, are not described any further.

The communication interface 402 provides a means for communicating with other apparatuses over a transmission medium. In some implementations, the communication interface 402 includes circuitry and/or programming adapted to facilitate the communication of information bi-directionally with respect to one or more communication devices in a network. In some implementations, the communication interface 402 is adapted to facilitate wireless communication of the administrator device 400. In these implementations, the communication interface 402 may be coupled to one or more antennas 412 as shown in FIG. 4 for wireless communication within a wireless communication system. In some implementations, the communication interface 402 may be configured for wire-based communication. For example, the communication interface 402 could be a bus interface, a send/receive interface, or some other type of signal interface including drivers, buffers, or other circuitry for outputting and/or obtaining signals (e.g., outputting signal from and/or receiving signals into an integrated circuit). The communication interface 402 can be configured with one or more standalone receivers and/or transmitters, as well as one or more transceivers. In the illustrated example, the communication interface 402 includes a transmitter 414 and a receiver 416. The communication interface 402 serves as one example of a means for receiving and/or means transmitting.

The processor 406 may be responsible for managing the bus 410 and general processing, including the execution of software stored on the non-transient computer readable medium 408. The software, when executed by the processor 406, may cause the processor 406 to perform the various functions described below for any particular apparatus or module. The non-transient computer readable medium 408 and the working memory device 404 may also be used for storing data that is manipulated by the processor 406 when executing software.

One or more processors, such as processor 406 in the administrator device 400 may execute software. Software may be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transient computer readable medium, such as non-transient computer readable medium 408. Non-transient computer readable medium 408 may include, by way of example, a magnetic storage device (e.g., hard disk, floppy disk, magnetic tape, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable non-transient medium for storing software, date, and/or instructions that may be accessed and read by a computer or the processor 406. Computer readable media may also include, by way of example, a carrier wave, a transmission line, and any other suitable medium for transmitting software and/or instructions that may be accessed and read by a computer or the processor 406. The non-transient computer readable medium 408 may reside in the administrator device 400, external to the administrator device 400, or distributed across multiple entities including the administrator device 400.

The processor 406 is arranged to obtain, process and/or send data, control data access and storage, issue commands, and control other desired operations. The processor 406 may include circuitry configured to implement desired programming provided by appropriate media in at least one example.

The non-transient computer readable medium 408 may be embodied in a computer program product. By way of example, a computer program product may include a computer readable medium in packaging materials. Those skilled in the art will recognize how best to implement the described functionality presented throughout this disclosure depending on the particular application and the overall design constraints imposed on the overall system.

In some aspects of the disclosure, the processor 406 may include circuitry configured for various functions. For example, the processor 406 may include a circuit/module for operating 420 and configured to manage the survey and to perform input/output operations associated with access to the Internet web and perform, for example, methods described herein. For example, the processor 406 may include a data storage 422 system/function/module/device configured to store data including but not limited to participants' responses to the survey. For example, the processor 406 may include a file system/function/module/device 424 configured to control how data in local data storage and/or remote data storage is stored and retrieved. For example, the processor 406 may include a survey system/function/module/device 426 configured to generate and transmit survey questions to a participant and collect the responses to the survey questions. For example, the processor 406 may include an analyzer system/function/module/device 428 configured to process structured answers and sentiment indicators to generate a preliminary happiness score, sentiment score and/or emotional classification using scoring algorithms, rule-based logic, weighted scoring, or machine learning models. For example, the processor 406 may include a happiness verification system/function/module/device 430 configured to display how many survey participants changed how they felt, stayed the same, went up (happier), went down (unhappier). For example, the processor 406 may include a verified sentiment results system/function/module/device (i.e. verified emotional sentiment data based on user confirmation or correction of the inferred emotional sentiment) 432 configured to present the user presents the user with a confirmation feeling question, prompting the user to verify or revise the emotional sentiment that has been inferred or calculated from their responses.

In some aspects of the disclosure, the non-transient computer readable medium 408 of the administrator device 400 may include instructions that may cause the various systems/functions/modules/devices of the processor 406 to perform the methods described herein. For example, the non-transient computer readable medium 408 may include operating instructions or code 434 to the circuit/module for operating 420. For example, the non-transient computer readable medium 408 may include a data storage instructions 436 corresponding to the data storage system/function/module/device 422. For example, the non-transient computer readable medium 408 may include file system instructions 438 corresponding to the file system/function/module/device 424. For example, the non-transient computer readable medium 408 may include survey instructions 440 corresponding to the survey system/function/module/device 426. For example, the non-transient computer readable medium 408 may include analyzer instructions 442 corresponding to the analyzer system/function/module/device 428. For example, the non-transient computer readable medium 408 may include happiness verified instructions 444 corresponding to the happiness verification system/function/module/device 430. For example, the non-transient computer readable medium 408 may include verified sentiment results (i.e. verified emotional sentiment data based on user confirmation or correction of the inferred emotional sentiment) instructions 446 corresponding to the verified emotional sentiment results (i.e. verified emotional sentiment data based on user confirmation or correction of the inferred emotional sentiment) system/function/module/device 432.

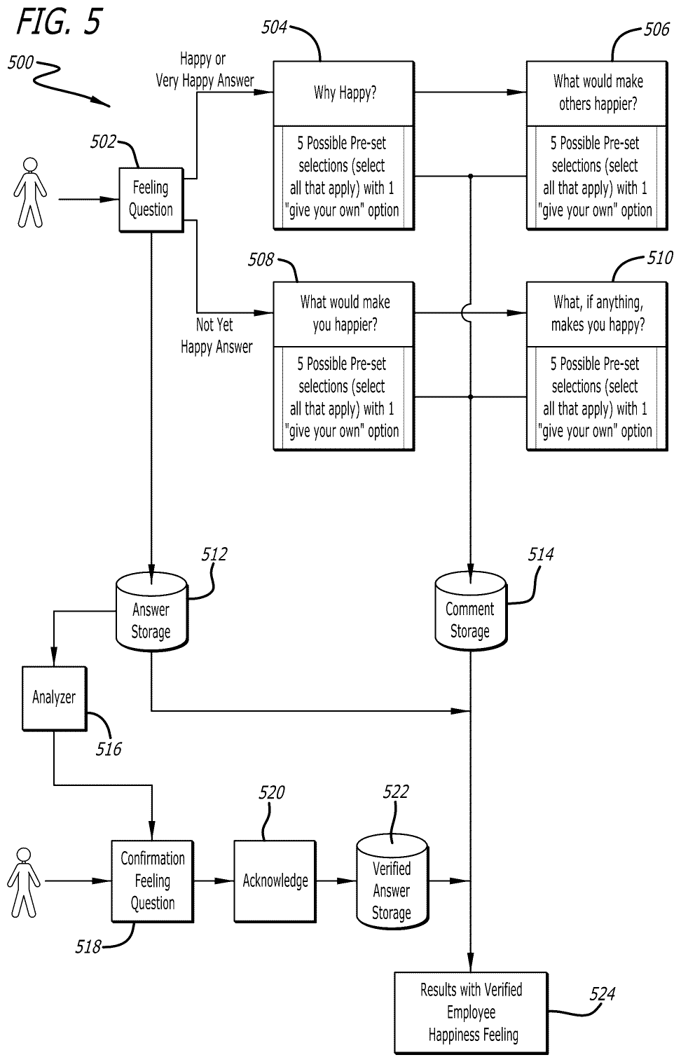

FIG. 5 illustrates a flow diagram 500 of a method for generating and displaying a happiness indicator based on user or participant responses to a digital survey, in accordance with one or more aspects of the present disclosure. The method ensures that user sentiment is both collected and confirmed before being incorporated into analytical results. The method may be implemented by a digital survey system such as that shown in FIG. 2.

First, a survey is presented to a user on a participant device 502. The survey includes a set of questions designed to assess aspects of the user's experience, satisfaction, or emotional state (i.e. feelings) in relation to a workplace or other environment.

Next, the user provides responses to the survey questions presented which may include multiple-choice selections, happiness scale ratings, or other structured input formats. If the user indicates that they are happy or very happy, the survey proceeds to request additional context by asking why they are happy. In one aspect, the survey presents the user with a list of predefined reasons for happiness, along with an option to write in a personalized response 504. As a follow-up, the survey may ask what the user believes would make others happier, again offering both pre-set options and a free-text field 506. Although FIG. 5 states “5 possible pre-set selections”, this by example only and there may be more than 5 or less than 5 possible pre-set selections.

If instead the user indicates that they are not yet happy, the survey dynamically shifts to inquire what would make them happier. The user is shown a selection of potential reasons, along with a write-in field for specifying an unlisted cause 508. A subsequent question may again invite the user to elaborate on what, if anything, would make them happier, using a similar interface with preset and free-form options 510. Although FIG. 5 states “5 possible pre-set selections”, this by example only and there may be more than 5 or less than 5 possible pre-set selections.

Once responses have been submitted, all structured survey responses are electronically transmitted to, and saved in, a data repository or answer storage 512. Simultaneously, any narrative or open-ended user input is electronically transmitted to, and stored in, a comment repository or comment storage 514, allowing for later qualitative analysis, review by administrators, and/or comments summaries summarizing all the comments.

Next, the collected data is analyzed by an analyzer module 516 that processes the structured answers and sentiment indicators to generate a preliminary happiness score, sentiment score and/or emotional classification. This may be accomplished through scoring algorithms, rule-based logic, weighted scoring, or machine learning models.

To ensure accuracy and trust, the system then presents the user with a confirmation feeling question 518, prompting the user to verify or revise the emotional sentiment data that has been inferred or calculated from their responses.

If the user confirms the emotional sentiment data, the system acknowledges the confirmation 520. The confirmed sentiment (i.e., emotional sentiment data) and all associated input are then electronically transferred to verified answer storage 522, representing verified emotional sentiment data ready for analytical use.

Finally, the verified data is compiled into results with verified employee happiness feeling, which may be aggregated and displayed in individual or group emotional sentiment data reports, trend visualizations, group comparisons, or feedback dashboards for organizational insights 524.

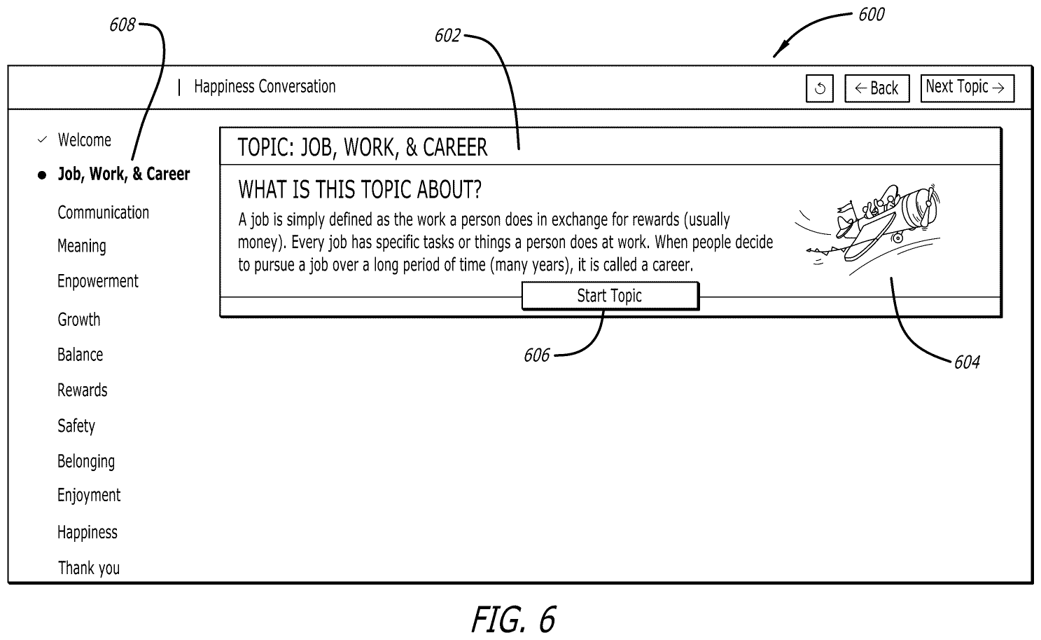

FIG. 6 illustrates an example graphical user interface (GUI) 600 representing a first screen in a happiness conversation sequence, in accordance with one or more aspects of the present disclosure. The GUI 600 is configured to introduce the user to a topic-based emotional check-in, beginning with the subject of “Job, Work, and Career.” As shown, the interface includes a prominent topic title area 602, which identifies the focus of the conversation, specifically, how the user feels about their professional experience, responsibilities, and work-related environment.

Below the topic title, the GUI 600 presents a descriptive overview 604 under the heading “What is this topic about?” This section provides contextual framing for the conversation, explaining that the forthcoming questions will explore the user's feelings and experiences related to their role, job satisfaction, growth opportunities, workload, and overall career alignment. In one aspect, the interface may include an introductory message or motivational phrase (e.g., “Let's talk about how you're feeling at work”) to set an open and supportive tone. This message helps ease the user into the emotional reflection process and reinforces psychological safety.

The GUI 600 may further include navigational elements or interactive buttons that allow the user to proceed to the next step of the conversation. These may be labeled with prompts such as “Start Topic” 606 or “Next,” enabling the user to continue the guided interaction at their own pace.

As further shown in FIG. 6, the graphical user interface (GUI) 600 includes a vertical navigation pane 608 located along the left-hand side of the screen. In accordance with one or more aspects of the present disclosure, the navigation pane 608 displays a sequential list of conversation topics, each corresponding to a specific screen the user will encounter during the emotional check-in process. Alternatively, the user may choose a specific topic from the sequential list of conversation topics to address.

The first item in the list, “Job, Work & Career,” is visually distinguished to indicate that it is the current active screen being presented. Below this, the navigation pane lists a series of forthcoming conversational topics, which include Communication, Meaning, Empowerment, Growth, Balance, Rewards, Safety, Belonging, Enjoyment, and Happiness.

Each topic in the list corresponds to a dedicated screen or module in the conversation flow, designed to guide the user through a structured exploration of how they feel about that particular aspect of their work or organizational experience. In one aspect, the list functions as both a progress tracker and a thematic map, helping users anticipate upcoming questions and understand the full scope of the conversation.

Topics may be presented in a fixed sequence or dynamically reordered based on user preferences, organizational priorities, or prior response data. As each topic is completed, it may be visually marked, e.g., with a checkmark, color change, or progress indicator, providing users with a clear sense of advancement through the emotional journey.

The navigation pane 608 supports aspects of the present disclosure directed to multi-dimensional emotional assessment, allowing users to reflect on a broad range of experience areas in a clear, transparent, and organized manner.

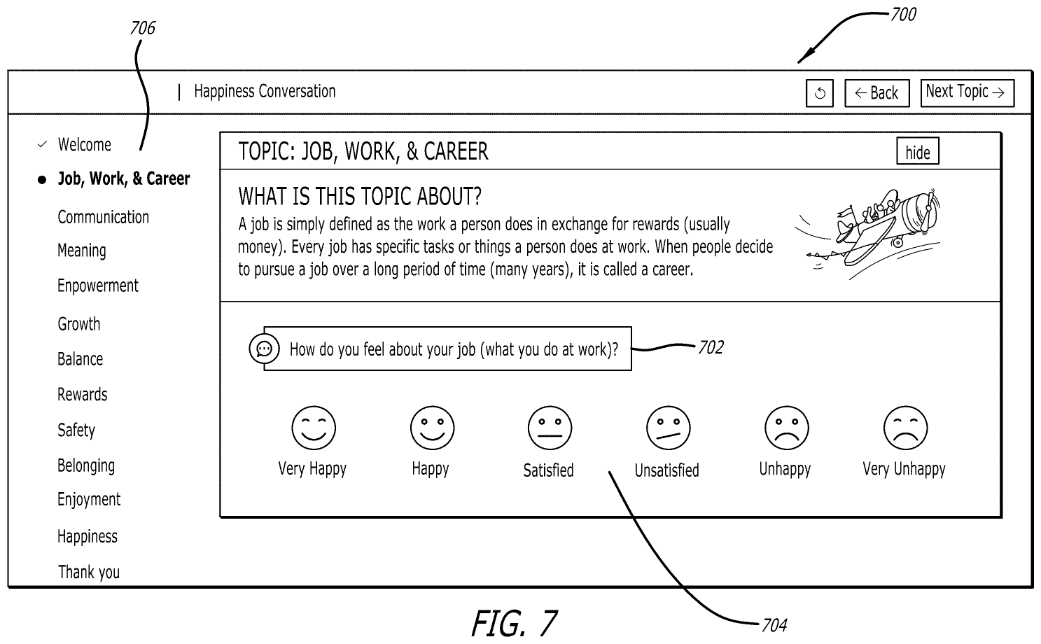

FIG. 7 illustrates an example graphical user interface (GUI) 700 representing a subsequent step in a topic-based happiness conversation, in accordance with one or more aspects of the present disclosure. FIG. 7 follows the introductory screen shown in FIG. 6 and initiates the first substantive user interaction by asking the user to indicate how they feel about the topic “Job, Work & Career.”

As shown, the GUI 700 includes a central question panel 702 prominently displaying a prompt such as “How do you feel about your job?” This question corresponds to the active topic introduced on the previous screen and is intended to elicit a self-reflective emotional response from the user. Beneath the question panel 702, the GUI 700 presents a series of selectable emotional response options 704 such as “Very Happy,” “Happy,” “Satisfied,” “Unsatisfied,” “Unhappy”, and “Very Unhappy.” These options are typically displayed as clickable buttons or icons and may include visual cues, such as color coding or expressive emoticons, to reinforce the sentiment conveyed by each label.

In one aspect, the interface may also provide a skip or defer option, allowing the user to move forward without providing an answer, thereby supporting user agency and comfort. The left-hand navigation pane 706 remains present, highlighting “Job, Work & Career” as the current topic, and displaying the full list of upcoming topics introduced in FIG. 6. This pane 706 serves as a progress tracker and contextual reference throughout the multi-step emotional check-in.

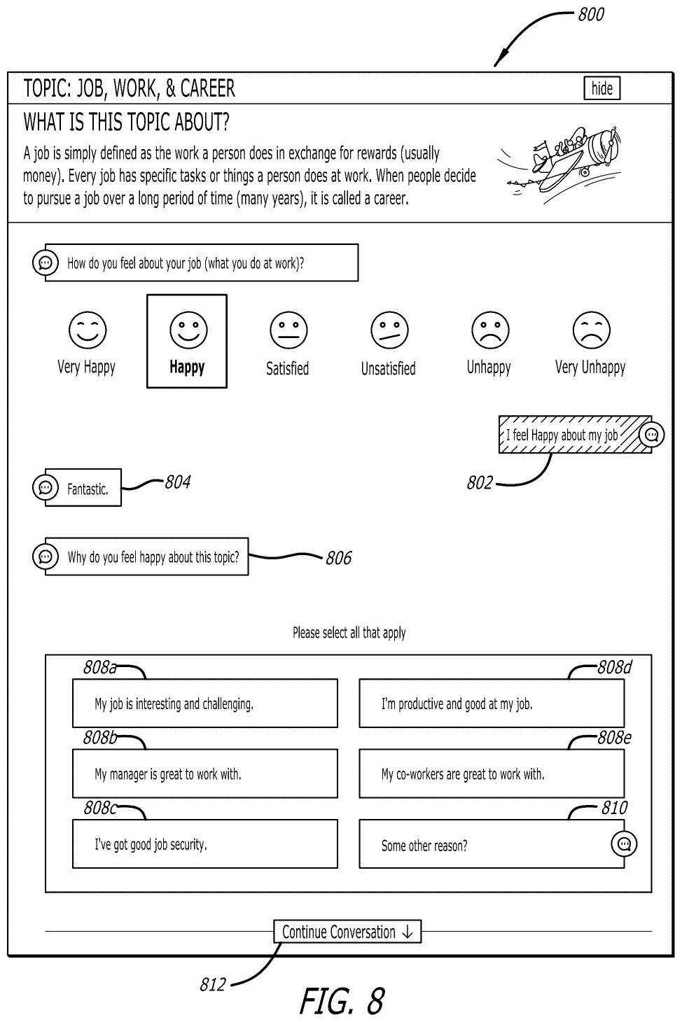

FIG. 8 illustrates an example graphical user interface (GUI) 800 representing a follow-up screen in a topic-based happiness conversation, in accordance with one or more aspects of the present disclosure. This screen is presented to the user after they have selected an emotional sentiment in response to the prompt shown in FIG. 7 (e.g., “How do you feel about your job?”).

As shown, GUI 800 includes a summary sentiment banner 802, prominently displaying a restatement of the user's selected response, for example, “I feel happy about my job.” This banner reinforces the user's earlier selection and sets the emotional tone for the personalized follow-up.

Directly above or adjacent to the banner is a positive affirmation box 804, such as “Fantastic”, which serves as an encouraging, affirming reaction from the system in response to the user's sentiment. In one aspect, this affirmation may be dynamically generated based on the positivity of the user's selected emotional state (e.g., happy or very happy). Below the sentiment banner, the system presents a follow-up prompt 806, such as “Why do you feel happy about this topic?”, designed to elicit additional insight. If the user had reported feeling unhappy, this prompt would be dynamically adjusted to ask what might improve their experience.

A set of predefined selectable options 808a-808e is provided under the follow-up prompt, representing common factors contributing to workplace satisfaction. These may include options like “My job is interesting and challenging”, “My manager is great to work with,” “I got good job security”, “I am productive and good at my job”, and/or “My co-workers are great to work with.” In addition to the structured options, the interface includes an open-text input field 810 that invites the user to write in their own reason for feeling the way they do. That is, the user can optionally provide their own user-submitted (i.e., associated) commentary or written comments. This enables personalized feedback that may not be captured by the preset options. Although 5 selectable options are shown, this is by way of example only and there may be more than 5 or less than 5 selectable options. This hybrid input model promotes flexibility while also allowing for structured data analysis. Once the user is satisfied with their answers, they may then continue on with the conversation/survey 812.

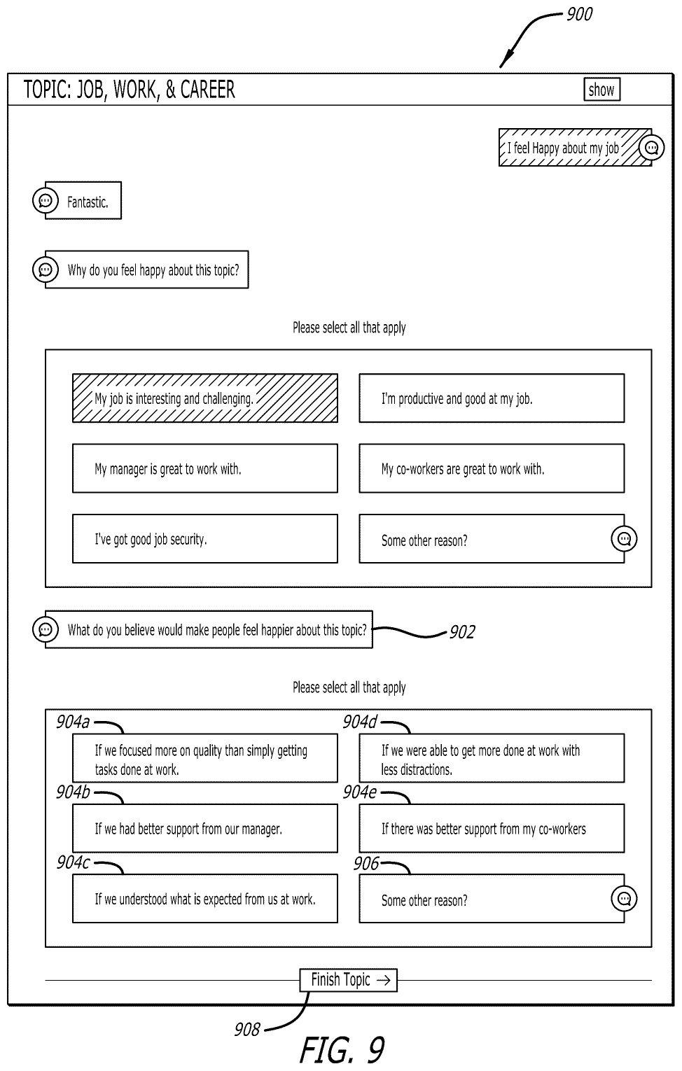

FIG. 9 illustrates an example graphical user interface (GUI) 900 representing a follow-up screen in a topic-based happiness conversation, in accordance with one or more aspects of the present disclosure. This screen is presented after the user has previously indicated feeling happy about their job and selected “My job is interesting and challenging” as the reason for that sentiment.

As shown, the GUI 900 includes a follow-up question panel 902 that asks the user to consider others in their workplace by presenting the prompt: “What do you believe would make people feel happier about this topic?” This question transitions the emotional check-in from self-reflection to empathetic perspective-taking, allowing the system to capture broader organizational insights.

Below the question 902, the interface includes a set of predefined selectable options 904a-904e, such as “If we focused more on quality than simply getting tasks done at work” 904a, “If we had better support from our manager” 904b, “If we understand what is expected from us at work” 904c, “If we were able to get more done at work with less distractions” 904d, and “If there was better support from my co-workers” 904e. These options are intended to help the user quickly identify likely sources of improvement for others. Additionally, an open-text input field 906 is provided, allowing the user to write in a custom response not captured by the predefined list. That is, the user can optionally provide their own user-submitted (i.e., associated) commentary or written comments. This enables the system to collect nuanced feedback based on the user's observations or experiences regarding coworkers or the broader work environment. Although 5 selectable options are shown, this is by way of example only and there may be more than 5 or less than 5 selectable options. Once the user is satisfied with their answers, they may then continue on with the conversation/survey 908.

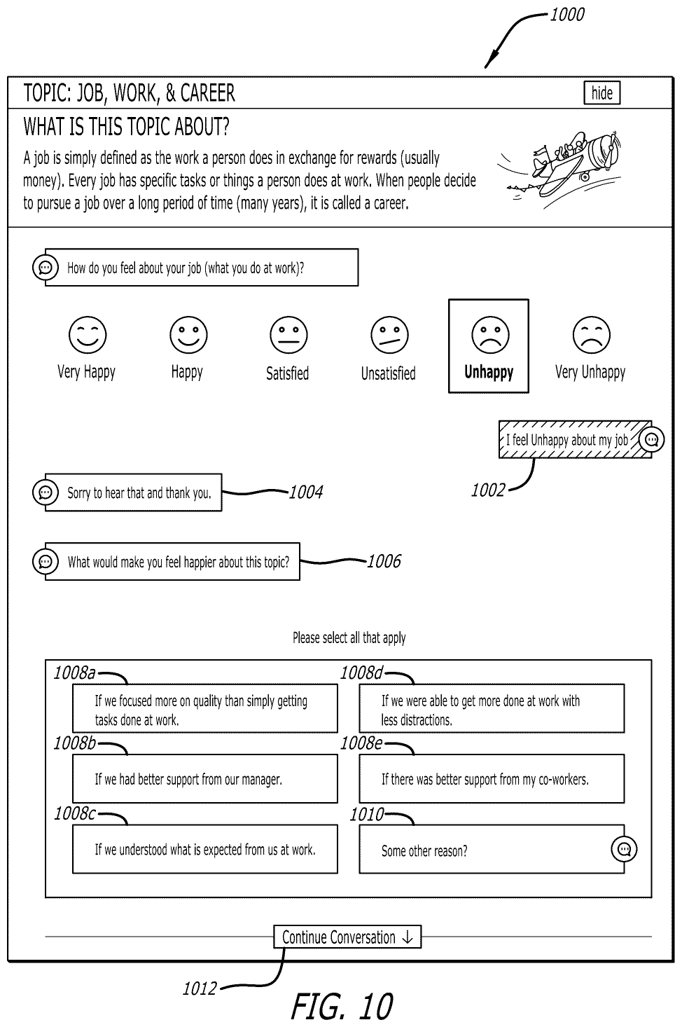

FIG. 10 illustrates an example graphical user interface (GUI) 1000 presented during a topic-based happiness conversation, in accordance with one or more aspects of the present disclosure. This screen is displayed when a user has responded to the question “How do you feel about your job?” (as shown in FIG. 7) with an indication that they are not happy at work.

As shown, the GUI 1000 includes a summary sentiment banner 1002, which restates the user's selected response. For example, the banner may display: “I feel unhappy about my job”, reinforcing the user's sentiment and setting the context for targeted follow-up.

Directly above or adjacent to the banner 1002 is a supportive affirmation box 1004, such as “Sorry to hear that and thank you”, which serves to elicit constructive insight from the user by identifying potential changes or improvements.

Below the sentiment banner, the system presents a follow-up prompt or question 1006, such as “What would make you feel happier about this topic?”, designed to elicit additional insight. If the user had reported feeling unhappy, this prompt would be dynamically adjusted to ask what might improve their experience.

A set of predefined selectable options 1008a-1008e is provided under the follow-up prompt, representing common factors contributing to workplace satisfaction. These may include options like “If we focused more on quality than simply getting tasks done at work”, “If we had better support from our manager”, “If we understood what is expected from us at work”, “If we were able to get more done at work with less distractions”, and/or “If there was better support from my co-workers”. In addition to the structured options, the interface includes an open-text input field 1010 that invites the user to write in their own reason for feeling the way they do. That is, the user can optionally provide their own user-submitted (i.e., associated) commentary or written comments. This enables personalized feedback that may not be captured by the preset options. Although 5 selectable options are shown, this is by way of example only and there may be more than 5 or less than 5 selectable options. Once the user is satisfied with their answers, they may then continue on with the conversation/survey 1012.

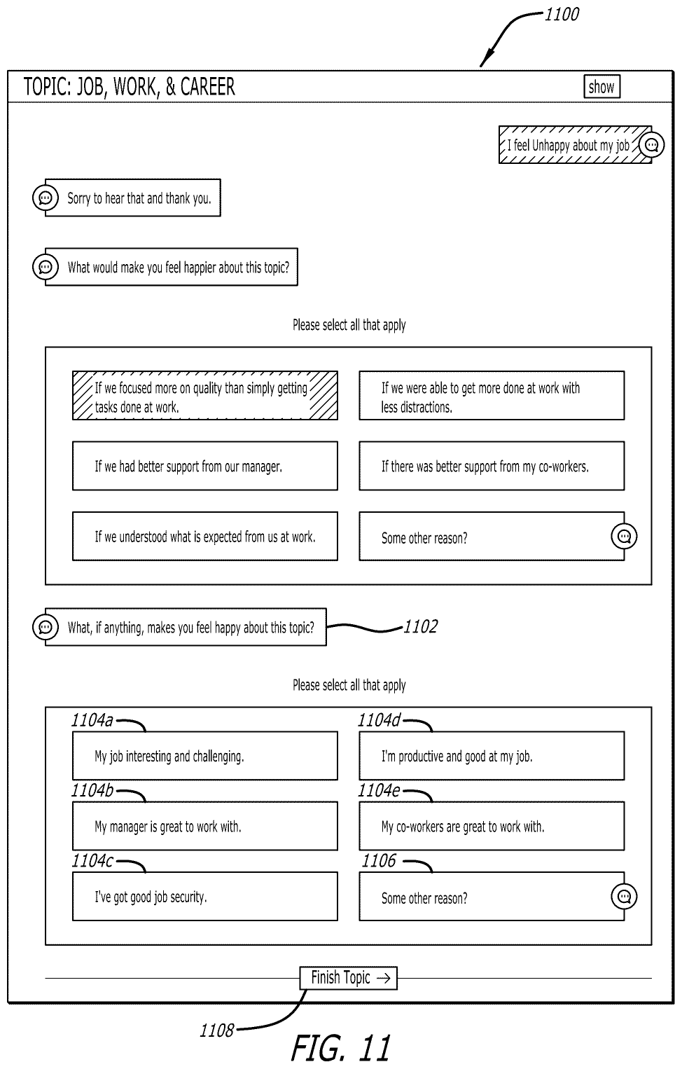

FIG. 11 illustrates an example graphical user interface (GUI) 1100 representing a follow-up screen in a topic-based happiness conversation, in accordance with one or more aspects of the present disclosure. This screen is presented after the user has previously indicated feeling unhappy about their job and selected “If we focused more on quality than simply getting tasks done at work” as the reason for that sentiment and is now invited to reflect more deeply on that specific topic.

As shown, the GUI 1100 includes a follow-up question panel 1102 that asks the user to consider others in their workplace by presenting the prompt: “What, if anything, makes you feel happy about this topic?” This question transitions the emotional check-in from self-reflection to empathetic perspective-taking, allowing the system to capture broader organizational insights.

Below the question 1102, the interface includes a set of predefined selectable options 1104a-1104e, such as “My job is interesting and challenging” 1104a, “My manger is great to work with” 1104b, “I've got good job security” 1104c, “I'm productive and good at my job” 1104d, and “My co-workers are great to work with” 1104e. These options are intended to help the user quickly identify likely sources of improvement for others. Additionally, an open-text input field 1106 is provided, allowing the user to write in a custom response not captured by the predefined list. That is, the user can optionally provide their own user-submitted (i.e., associated) commentary or written comments. This enables the system to collect nuanced feedback based on the user's observations or experiences regarding coworkers or the broader work environment. Although 5 selectable options are shown, this is by way of example only and there may be more than 5 or less than 5 selectable options. Once the user is satisfied with their answers, they may then continue on with the conversation/survey 1108.

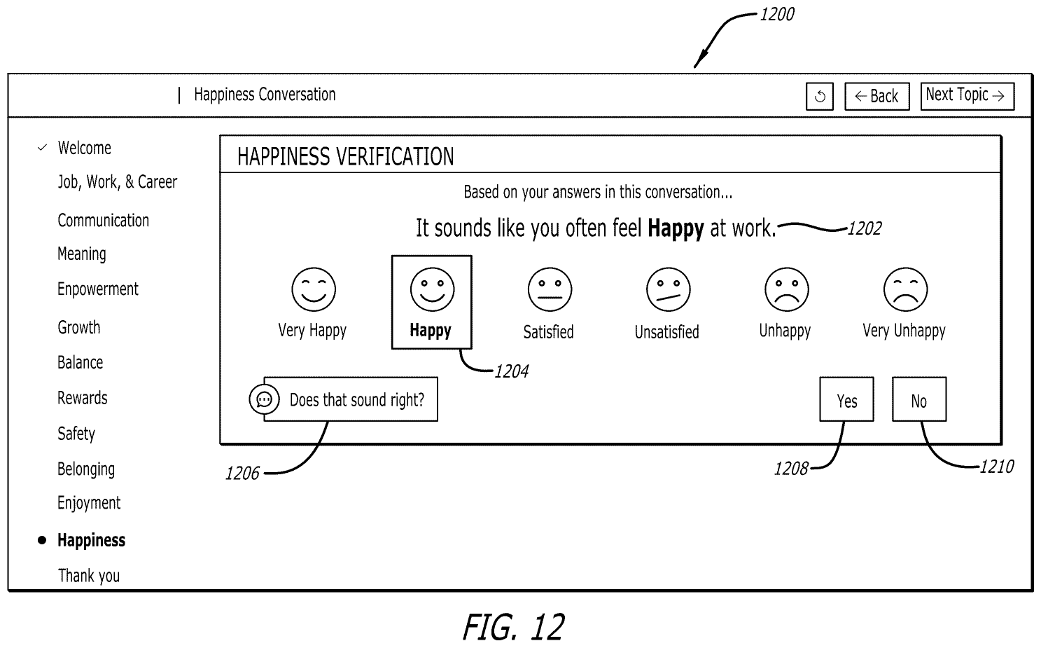

FIG. 12 illustrates an example graphical user interface (GUI) 1200 configured to present a happiness verification screen, in accordance with one or more aspects of the present disclosure. This screen is shown near the end of a topic-based emotional check-in and is designed to confirm with the user whether the system's interpretation of their typical emotional state is accurate.

As shown, the GUI 1200 includes a summary verification message 1202 that states “You often feel happy about your job.” This statement is derived from the user's previous selections and emotional feedback submitted during the check-in process for the “Job, Work & Career” topic. Adjacent to the message, the interface includes a visual sentiment icon 1204, such as a smiling emoji, representing the happiness level inferred from the user's input. The icon serves as an intuitive emotional cue to reinforce the summary text.

Beneath the summary and icon, the system presents a follow-up question 1206 that asks, “Does that sound right?” This prompt is designed to verify the system's interpretation by giving the user a clear opportunity to confirm or revise the emotional summary.

The interface includes two response options, (1) a confirmation button labeled “Yes” 1208 and (2) a correction button labeled “No” 1210. These options allow the user to either affirm the emotional assessment or revisit their prior responses for adjustment.

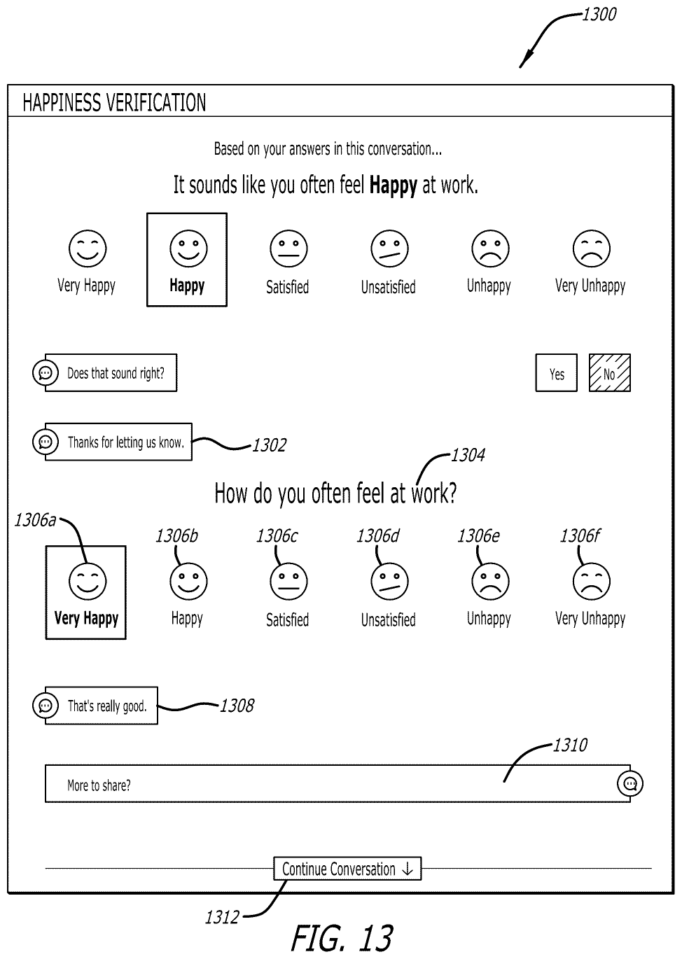

FIG. 13 illustrates an example graphical user interface (GUI) 1300 configured to facilitate user correction of an inferred emotional sentiment, in accordance with one or more aspects of the present disclosure. This screen follows the verification interface shown in FIG. 12, where the system suggested that the user often feels happy at work.

As shown, GUI 1300 reflects the scenario in which the user selected “No” in response to the prior confirmation prompt. In response, the system displays an acknowledgment message 1302 stating, “Thanks for letting us know.” This message is intended to verify the user's input and maintain an empathetic tone during the correction process.

The interface then presents a new prompt 1304 asking “How do you often feel at work?” This question invites the user to directly specify their most frequent emotional experience related to their job. A set of emotionally expressive icon options 1306a-1306f is displayed below the prompt, representing a range of sentiment levels from very unhappy to very happy. The user in this scenario selects the “Very Happy” icon 1306a, indicating a highly positive emotional baseline. Upon receiving this input, the system immediately responds with a reinforcement message 1308, such as, “That's really good.” This message serves to affirm the updated sentiment and encourage continued engagement.

Following this, the interface presents a prompt “More to share?” 1310, which includes one or more follow-up prompts designed to gather optional commentary or elaboration. Once the user is satisfied with their answers, they may then continue on with the conversation/survey 1312.

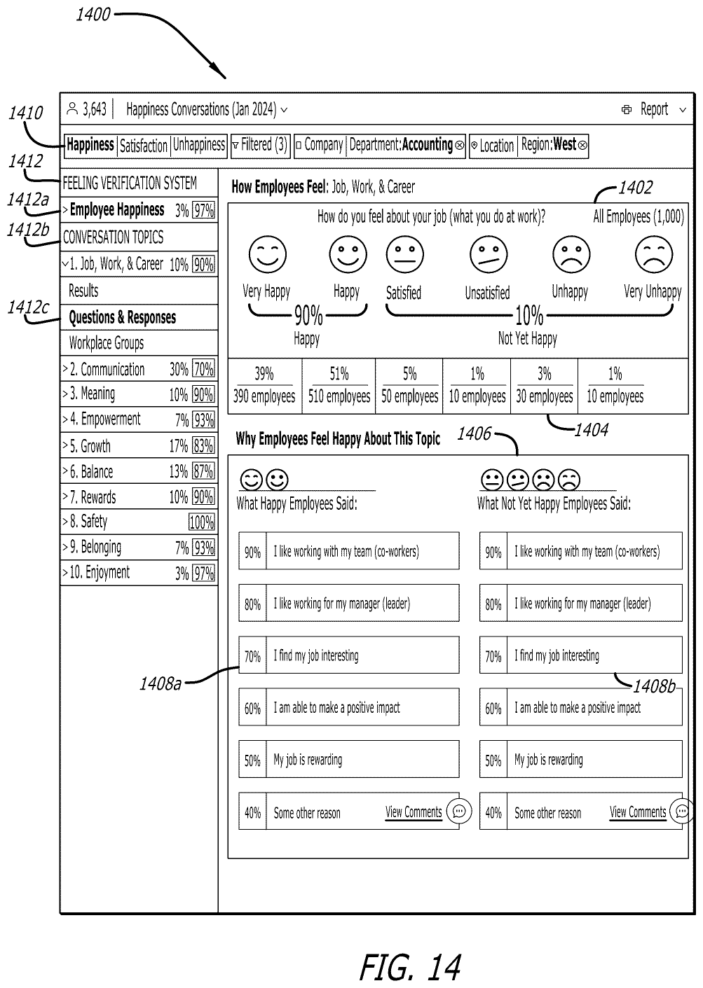

FIG. 14 illustrates an example graphical user interface (GUI) 1400 configured to present a happiness conversations report, in accordance with one or more aspects of the present disclosure. This interface is intended for use by administrators, managers, or human resource personnel to review and analyze employee emotional sentiment data gathered through a topic-based emotional survey process.

At the top of the GUI, the system presents a high-level sentiment summary 1402, indicating that 90% of employees are either “very happy” or “happy”, while 10% are “not yet happy” about the given topic. These values are derived from employee selections during the emotional check-in process and are visually reinforced through expressive sentiment icons. Below the summary, the GUI includes an emotion distribution panel 1404, in which each sentiment icon, ranging from very happy to unhappy, is accompanied by two key metrics, (1) the total number of employees who selected each sentiment, and (2) the percentage of total responses that selection represents. These metrics may be displayed directly beneath each corresponding icon, enabling quick interpretation of sentiment breakdowns across the employee population.

Further down the interface, a section labeled “Why employees feel happy about this topic” 1406 provides a summary of common themes or explanations given by employees who reported positive sentiment. This may include key phrases or aggregated topics drawn from structured input or free-text responses. The GUI then displays two side-by-side comment lists, i.e. first ands second lists 1408a and 1408b. The first list 1408a is a list of anonymized comments provided by employees who reported feeling happy or very happy about the topic. The second list 1408b, a list of anonymized comments from employees who indicated they are not yet happy, offering insight into perceived challenges or unmet needs.

Each comment may be presented in plain text and is attributed to the associated sentiment group, allowing organizational reviewers to compare positive and negative employee experiences in a single, cohesive view.

As further shown in FIG. 14, the graphical user interface (GUI) 1400 includes a filtering toolbar 1410 positioned at the top of the report screen. In accordance with one or more aspects of the present disclosure, this toolbar enables administrative users to dynamically segment and analyze emotional sentiment data based on a variety of predefined categories. The filtering toolbar 1410 allows the user to select from multiple sentiment-based filters, such as: Happiness, Satisfaction, Unhappiness. These options may be used to isolate specific emotional responses and view detailed breakdowns or trends across the selected category.

In addition, the filtering toolbar includes organizational and demographic filters, enabling further refinement of the data. These filters include Company (for multi-brand or enterprise-wide surveys), Department (e.g., Marketing, Engineering, Sales), Location or Region (e.g., by office, city, or country), and Gender of Employee. Each filter may be presented as a dropdown menu, checkbox selector, or segmented button, allowing for single or multi-select configurations. When filters are applied, the emotional sentiment data summary, icon-based distribution, and comment sections update accordingly to reflect the selected subset of responses.

In one aspect, the filtering toolbar 1410 may also support real-time interaction, enabling administrators to rapidly switch between categories or drill down into specific subgroups to identify localized issues or highlight areas of excellence. This filtering capability supports aspects of the present disclosure directed to targeted sentiment analytics and organizational insights, allowing data reviewers to explore emotional trends not only at the aggregate level but also within specific populations or business units for more effective decision-making.

As further illustrated in FIG. 14, the graphical user interface (GUI) 1400 includes a feeling verification system pane 1412 located along the side of the report interface. In accordance with one or more aspects of the present disclosure, this pane 1412 provides detailed, drill-down views of individual or aggregated survey data to support review, verification, and audit of emotional sentiment data responses.

The verification pane 1412 comprises multiple structured sections, such as, (1) Employee Happiness 1412a which displays the verified or self-reported emotional status of a given employee or group of employees with respect to the selected conversation topic. It may include a sentiment label (e.g., “Happy,” “Very Happy,” “Not Yet Happy”) along with a timestamp or confirmation status indicating whether the feeling was explicitly confirmed by the user; (2) Conversation Topics 1412b that list the topic(s) associated with the employee's responses, such as “Job, Work & Career,” “Communication,” or “Growth.” The active topic is typically highlighted, allowing the viewer to correlate sentiment and commentary within specific thematic contexts; and (3) Questions and Responses 1412c which provides a structured log of survey prompts and the associated answers given by the employee. It may display both multiple-choice selections and free-text responses, allowing administrators to review the original emotional input and any follow-up elaboration.

In some aspects, the feeling verification pane 1412 may also include metadata such as employee role (i.e., the job of the employee), department, or location, and may support interactive functionality such as expanding/collapsing question groups, searching by keywords, or flagging responses for follow-up.

The inclusion of this pane 1412 supports aspects of the present disclosure directed to transparent emotional data verification, allowing authorized users to trace sentiment summaries back to their underlying data points and ensure that emotional insights used for decision-making are accurate, contextual, and traceable.

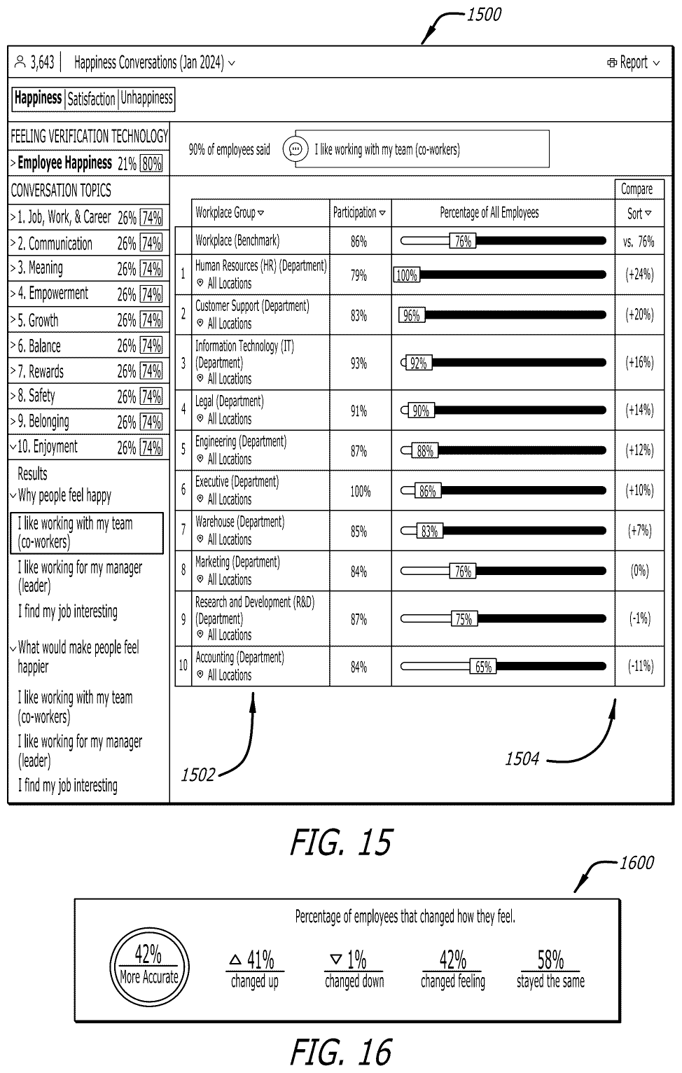

FIG. 15 illustrates an example graphical user interface (GUI) 1500 representing a continuation of the happiness conversations report, in accordance with one or more aspects of the present disclosure. This screen provides a workplace group comparison view, enabling administrators to analyze segmented emotional sentiment data across organizational units based on a specific employee-identified driver of happiness.

The view shown in FIG. 15 is filtered to display only the results from employees who responded with “I like working with my team (co-workers)” during the happiness conversation. This selected response reflects a positive driver of emotional sentiment and serves as the basis for the comparative analysis shown.

As shown, the GUI 1500 displays a structured table or matrix 1502, in which each row corresponds to a distinct workplace group, such as a department, location, team, or functional unit. Each group is evaluated against a common set of emotional sentiment metrics related to a specific conversation topic. For each group, the report includes the following data: (1) Participation count: The total number of employees in the group who responded to the conversation and selected the specified sentiment driver; (2) Response rate: The percentage of the group's total population that submitted this response; (3) Sentiment indicator: Visual representations—such as icons, colored bars, or sentiment labels—showing how employees in each group felt about the topic (e.g., “Very Happy,” “Happy,” or “Not Yet Happy”).

Alongside each group's data, the GUI includes a comparison column 1504 showing how that group's sentiment compares to the overall workplace benchmark. This comparison may be rendered using differential scores, arrows, or visual offset bars, allowing reviewers to immediately assess which groups are aligned with or diverging from broader organizational trends.

In some aspects, the interface allows administrators to sort or filter the results based on participation, sentiment positivity, or group name, and may include color-coded indicators to highlight areas of concern or exceptional performance.

FIG. 16 illustrates an example graphical user interface (GUI) 1600 configured to display the enhanced level of accuracy that the happiness verification has provided this conversation, in accordance with one or more aspects of the present disclosure.

As shown, the GUI 1600 includes a summary panel that visually represents the proportion of users whose emotional state shifted, positively or negatively, compared to the suggested sentiment during the verification step. This may include segmented percentages for categories such as “became happier,” “became less happy,” or “no change.”

In one aspect, the data may be derived by comparing happiness scores or sentiment indicators from a prior survey session with those from a current session, on a per-user basis. The results are then aggregated and displayed in a simplified visual format, such as bar charts, percentage badges, or color-coded sections.

The GUI 1600 may also include additional filters or controls enabling an administrative user to narrow the analysis by time period, department, role, or location. This facilitates targeted review of where sentiment shifts are occurring within the organization.

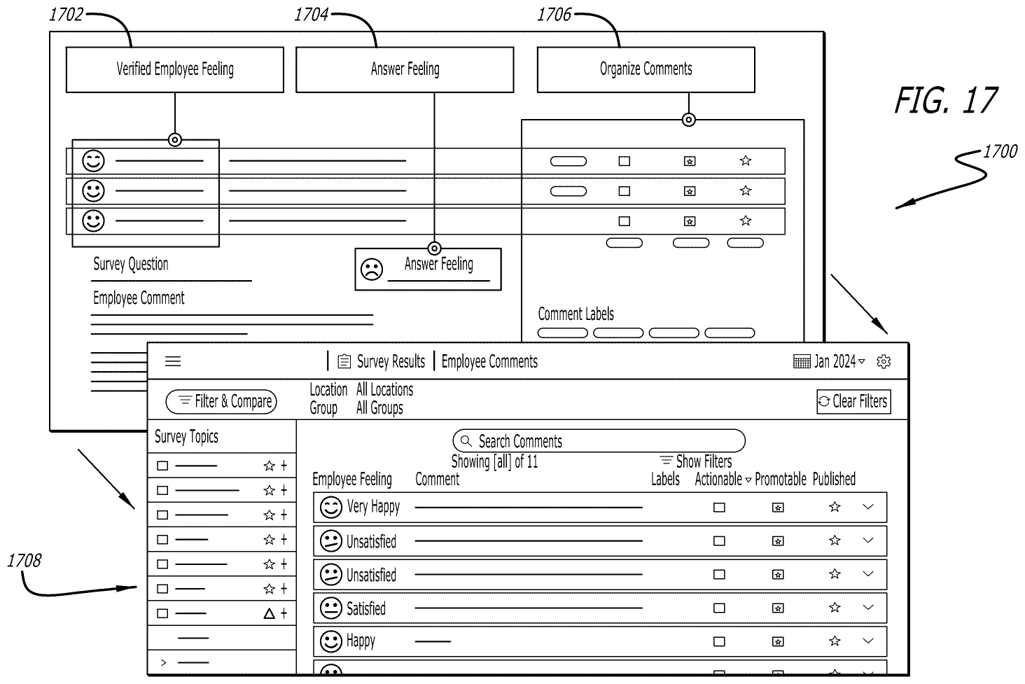

FIG. 17 illustrates an example graphical user interface (GUI) 1700 configured to facilitate administrative workflows related to employee emotional sentiment data management, in accordance with one or more aspects of the present disclosure. The GUI 1700 is designed to support administrative actions such as verifying employee records, collecting emotional feedback, and organizing open-ended commentary for review or escalation. It assists the administration to understand how employees feel before reading what they have to say.

As shown, the GUI 1700 includes a section labeled “Verified Employee Feeling” 1702, which provides administrative users with tools to confirm the identity or status of survey participants. This may include employee IDs, roles, departments, or other metadata relevant for authenticating or categorizing incoming survey data.

The interface also features an “Answer Feeling” 1704 section, where employee responses to emotional sentiment questions are collected and presented. In one aspect, this includes selected happiness indicators or mood levels as reported by users during the survey session.

A third section, labeled “Organize Comments” 1706, enables administrators to manage qualitative feedback submitted by users. This section may support tagging, categorization, sentiment labeling, or prioritization of comments for escalation or follow-up. In some aspects, natural language processing or keyword-based classification may be employed to streamline review and triage.

The main content of the GUI is presented in a results table 1708, where each row corresponds to a single employee survey entry. The table includes multiple labeled columns that enable comprehensive analysis and status tracking for each response. The first column displays the Survey Topic, identifying the particular theme or subject addressed by the employee's responses, e.g., “Job, Work & Career,” “Growth,” or “Communication.”

The second column shows the Employee Feeling, which reflects the emotional sentiment selected or verified by the employee during the check-in (e.g., “Happy,” “Very Happy,” or “Not Yet Happy”). This sentiment may be represented textually or via expressive icons.

The third column, labeled Comment/Labels, provides categorized tags summarizing the key themes of the employee's written feedback. These labels may be automatically generated using natural language processing or manually applied during administrative review (e.g., “recognition,” “stress,” “supportive manager”).

The fourth column, titled Actionable, indicates whether the employee's feedback includes a suggestion or concern that could be acted upon by management. This column may use binary status indicators (e.g., “Yes” or “No”) or icons to flag priority items.

The fifth column, Promotable, reflects whether the comment includes content that may be highlighted or shared in internal communications or positive reinforcement efforts. For example, feedback containing praise or motivational language may be marked as promotable.

The final column, Published, indicates the publication or visibility status of the entry. This may reflect whether the comment has been included in a report, shared with leadership, or made visible in an employee-facing dashboard. It may also support toggling for administrative control.

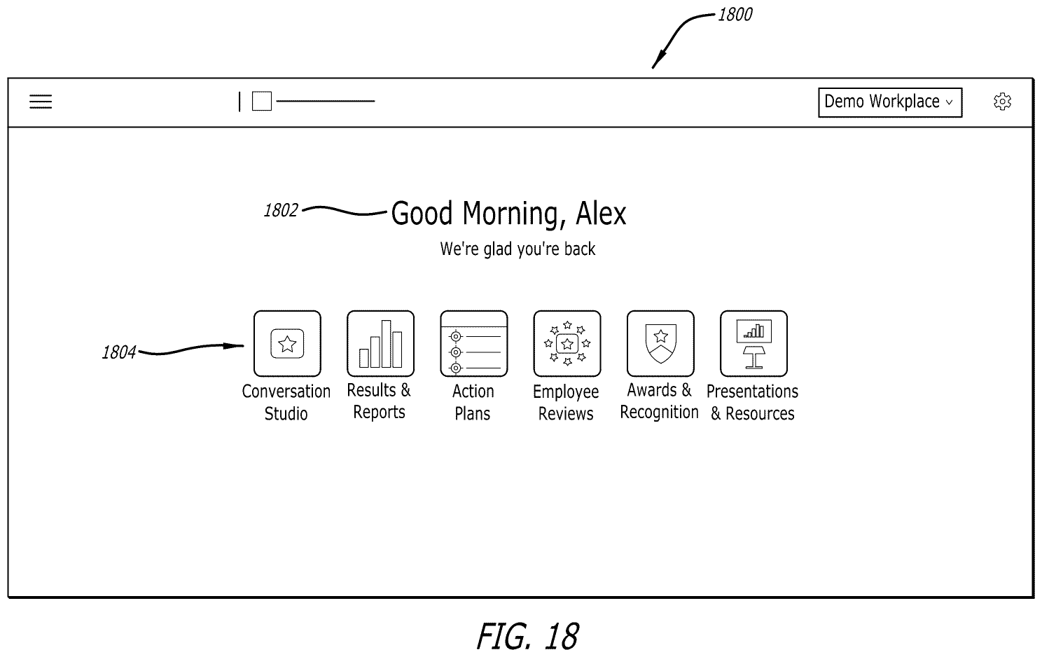

FIG. 18 illustrates an example graphical user interface (GUI) 1800 configured to serve as a welcome screen for returning users, in accordance with one or more aspects of the present disclosure. The interface is designed to reorient users within the platform and provide clear access to core functional modules related to employee sentiment analysis and workplace engagement.

At the top of the screen, the GUI displays a welcome message 1802 acknowledging the user's return to the system. This message may be personalized or generic and is intended to establish continuity and ease of re-entry into the workflow.

Below the message, the interface presents a selection panel 1804 comprising a set of interactive option tiles or buttons, each corresponding to a distinct feature area within the system. The available options shown in the figure include: (1) Conversation Studio: Enables users to create, manage, or refine survey topics and emotional conversation flows; (2) Results and Reports: Provides access to collected emotional sentiment data, analytics dashboards, and group or organization-wide summaries; (3) Action Plans: Allows users to design and monitor follow-up initiatives based on survey results, including sentiment-driven interventions; (4) Employee Reviews: Supports the integration or review of performance feedback and qualitative insights tied to individual employees; (5) Awards and Recognition: Offers tools for identifying and celebrating positive contributions or emotional impact across the workforce; and (6) Presentation and Resources: Grants access to communication tools, documentation, or training materials related to the platform's use or engagement strategy.

Although 6 options are shown, this is by way of example only and there may be more than 6 or less than 6 selectable options. Each option is represented visually using an icon or graphical element alongside a descriptive label and may be clickable to direct the user to the corresponding module. In some aspects, access to individual features may be role-based or personalized based on the user's prior activity or administrative permissions.

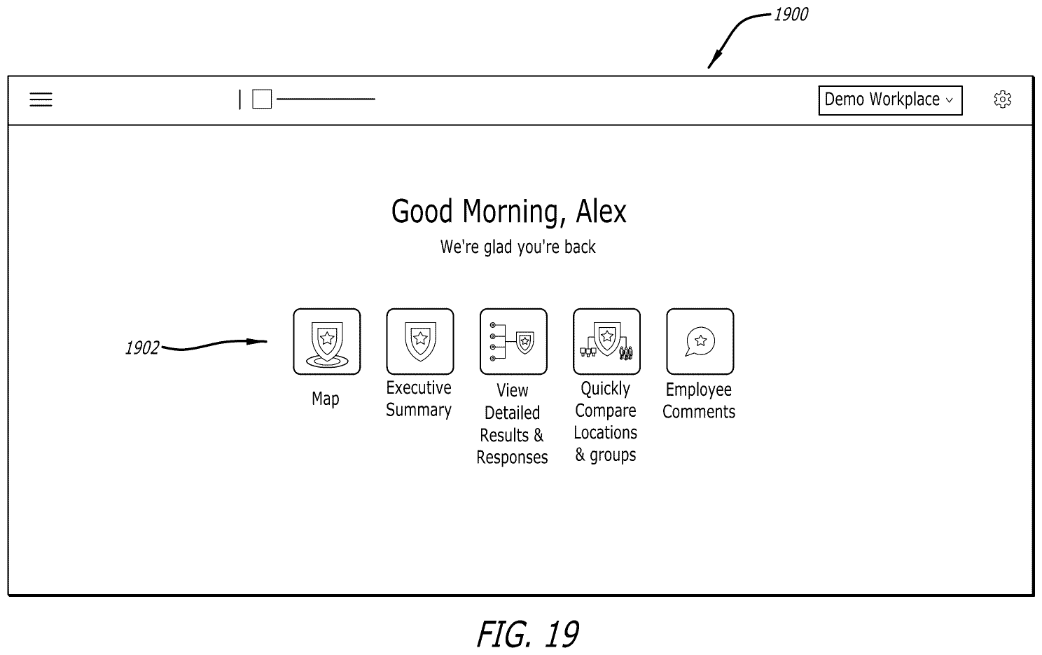

FIG. 19 illustrates an example graphical user interface (GUI) 1900 representing an alternative or supplemental welcome screen for returning users, in accordance with one or more aspects of the present disclosure. This screen is designed to offer streamlined access to key features related to data visualization, executive insights, comparative analysis, and employee feedback review.

Positioned below the message is a selection panel 1902 featuring a series of interactive tiles or buttons, each representing a core functionality for high-level organizational review and sentiment exploration. The available options include: (1) Map: Opens a geographic visualization interface that allows users to explore emotional sentiment data, participation, or trends by location or region; (2) Executive Summary: Presents a condensed overview of emotional trends, participation rates, key drivers of sentiment, and other high-level metrics intended for leadership review; (3) View Detailed Results and Responses: Directs the user to a comprehensive reporting interface that includes both quantitative results and qualitative employee feedback across all survey topics; (4) Quickly Compare Locations and Groups: Enables side-by-side comparison of emotional sentiment scores and engagement levels across departments, teams, or geographic areas; and (5) Employee Comments: Opens a dedicated module for reviewing open-text responses provided by employees during emotional check-ins, optionally filtered by sentiment category or topic. That is, the users or employees can optionally provide their own user-submitted (i.e., associated) commentary or written comments.

Although 5 options are shown, this is by way of example only and there may be more than 5 or less than 5 selectable options. Each option includes a visual icon and text label to guide the user and may provide hover-over descriptions or tooltips for additional context. In some aspects, visibility or accessibility of options may be determined by user role or organizational permission levels.

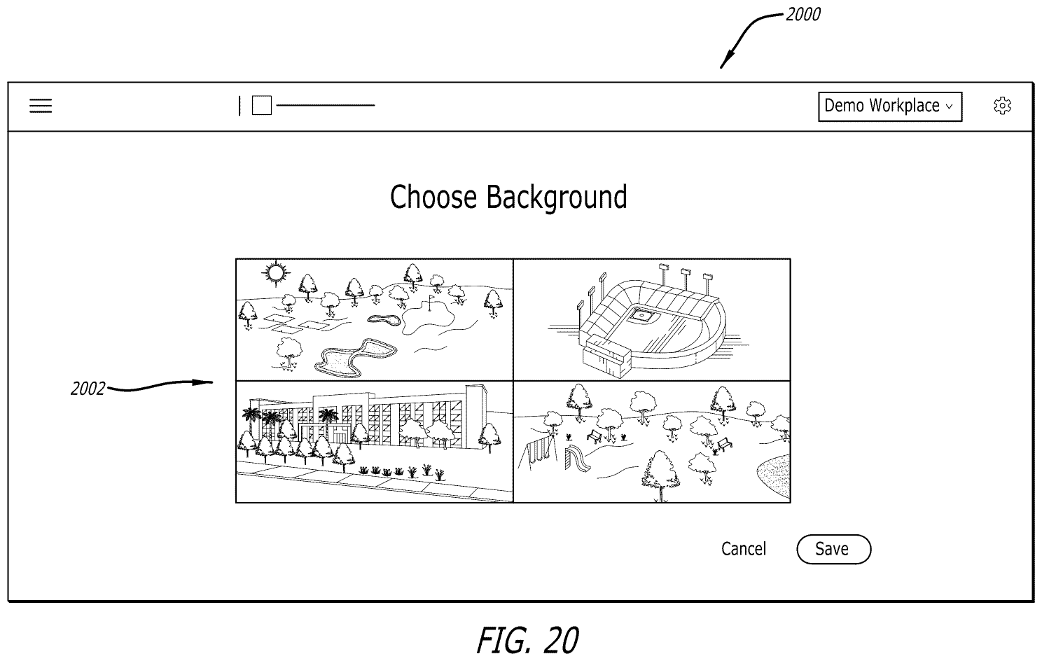

FIG. 20 illustrates an example graphical user interface (GUI) 2000 configured to enable a user to select a background image or theme for personalization of the survey or reporting environment, in accordance with one or more aspects of the present disclosure.

As shown, the GUI presents a selection panel 2002 featuring multiple visual background options displayed as thumbnails or preview tiles. Each tile represents a different aesthetic style or thematic backdrop that the user can choose to apply to their experience within the platform. In some aspects, background themes may include visual elements such as nature imagery, abstract patterns, solid colors, gradient styles, or workplace-relevant scenes. These options may be designed to enhance user comfort, match organizational branding, or support accessibility preferences. The user may interact with the interface by clicking or tapping a selected background tile, which triggers the system to apply the chosen design to subsequent screens or interfaces. A visual indicator (e.g., border highlight or checkmark) may appear on the currently selected option.

The system may further store the user's selection as part of their user profile, allowing the chosen background to persist across sessions or devices. In some implementations, background selections may also be role-specific (e.g., admin vs. employee) or applied platform-wide by organizational administrators. Although 4 options are shown, this is by way of example only and there may be more than 4 or less than 4 selectable options.

### CONCLUSION

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. The terms “at least one” and “one or more” may be used interchangeably herein.

Within the present disclosure, use of the construct “A and/or B” may mean “A or B or A and B” and may alternatively be expressed as “A, B, or a combination thereof” or “A, B, or both”. Within the present disclosure, use of the construct “A, B, and/or C” may mean “A or B or C, or any combination thereof” and may alternatively be expressed as “A, B, C, or any combination thereof”.

One or more of the components, steps, features and/or functions illustrated herein may be rearranged and/or combined into a single component, step, feature, or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of:” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

What is claimed is:

1. A computing system for collecting, verifying, and reporting data from survey participants, comprising:
one or more participant devices, each configured to:
present a digital survey comprising a plurality of questions related to a topic of interest;
receive one or more responses from a user, including selected answers and optionally written comments; and
display a proposed emotional sentiment based on the one or more responses of the user and prompt the user to confirm or revise the proposed emotional sentiment;
a server comprising one or more processors and memory for storing instructions that, when executed, cause the server to:
receive and store the one or more responses from the one or more participant devices;
analyze the one or more responses to generate an inferred emotional sentiment for each user;
record a verified emotional sentiment based on user confirmation or correction of the inferred emotional sentiment;
associate written comments with the verified emotional sentiment; and
aggregate the verified data for presentation in one or more reporting interfaces;
an administrator interface configured to:
display aggregated emotional sentiment data and comment summaries for one or more workplace groups;
allow filtering of the aggregated emotional sentiment data based on one or more parameters including topic, department, location, or employee demographics; and
display visualizations showing sentiment distribution, group comparisons, and user-submitted commentary linked to aggregated emotional sentiment data.

2. The computing system of claim 1, wherein the memory is a non-transitory computer-readable storage medium; and wherein the instructions stored on the non-transitory computer-readable storage medium further cause the server to present, to the each user, a confirmation prompt asking whether the inferred emotional sentiment accurately reflects how the user feels.

3. The computing system of claim 1, wherein the server is further configured to update the verified emotional sentiment based on a user-selected correction to the proposed emotional sentiment.

4. The computing system of claim 1, wherein each written comment in the comment summaries submitted by the user is tagged with a label corresponding to the verified emotional sentiment of the user at a time the comment was submitted.

5. The computing system of claim 1, wherein the administrator interface is further configured to display a distribution of emotional sentiment values across a plurality of workplace groups in a comparative format.

6. The computing system of claim 1, wherein the administrator interface is configured to filter sentiment results by at least one of a survey topic, a department, a location, an employee role, and a demographic attribute.

7. The computing system of claim 1, wherein the administrator interface further displays employee comments in a format grouped by associated emotional sentiment.

8. The computing system of claim 1, wherein the server is configured to track and display changes in emotional sentiment over time for individual users or defined workplace groups.

9. A method for collecting, verifying, and reporting emotional sentiment data from survey participants, comprising:
presenting, via one or more participant devices, a digital survey comprising a plurality of questions related to a topic of interest;
receiving, from a user, one or more responses to the digital survey, including selected answers and optionally written comments;
analyzing the one or more responses to generate an inferred emotional sentiment for the user;
presenting the inferred emotional sentiment to the user and prompting the user to confirm or revise the inferred emotional sentiment;
receiving, from the user, a verified emotional sentiment;
associating the verified emotional sentiment with the one or more responses and any written comments;
storing the verified emotional sentiment in association with a survey record of the user; and
displaying, via an administrator interface, one or more visualizations of aggregated emotional sentiment data and associated commentary for individual users or workplace groups.

10. The method of claim 9, further comprising presenting a confirmation prompt to the user asking whether the inferred emotional sentiment accurately reflects how the user feels.

11. The method of claim 9, further comprising:
updating the verified emotional sentiment based on a user selection to revise the inferred emotional sentiment;
tagging each written comment submitted by the user with a label corresponding to the verified emotional sentiment; and
filtering the aggregated emotional sentiment data based on at least one of a survey topic, a department, a location, an employee role, and a demographic attribute.

12. The method of claim 9, wherein the one or more visualizations comprise a distribution of emotional sentiment values across a plurality of workplace groups.

13. The method of claim 9, further comprising:
grouping and displaying user-submitted comments according to the associated verified emotional sentiment; and
tracking changes in the associated verified emotional sentiment over time for individual users or predefined organizational groups.

14. A non-transitory computer-readable storage medium storing instructions that, when executed by one or more processors, cause a computing system to perform a method for collecting, verifying, and reporting emotional sentiment data, the method comprising:
presenting a digital survey to a user via a participant device, the digital survey comprising a plurality of questions related to a topic of interest;
receiving one or more survey responses from the user, including selected answers and optionally written comments;
analyzing the responses to generate an inferred emotional sentiment;
prompting the user to confirm or revise the inferred emotional sentiment;
recording a verified emotional sentiment based on input from the user;
associating the verified emotional sentiment with the one or more survey responses and any written comments;
aggregating the verified emotional sentiment data from multiple users; and
generating one or more visualizations of the aggregated verified emotional sentiment data for presentation through an administrator interface.

15. The non-transitory computer-readable storage medium of claim 14, wherein the instructions further cause the computing system to present a confirmation prompt asking the user to verify whether the inferred emotional sentiment accurately reflects how the user feels.

16. The non-transitory computer-readable storage medium of claim 14, wherein the instructions further cause the computing system to receive a revised emotional sentiment from the user and store the revised emotional sentiment as a verified emotional sentiment.

17. The non-transitory computer-readable storage medium of claim 14, wherein the instructions further cause the computing system to associate a label with each written comment submitted by the user, the label corresponding to the verified emotional sentiment.

18. The non-transitory computer-readable storage medium of claim 14, wherein the instructions further cause the computing system to filter the aggregated verified sentiment data based on at least one of: a topic, a department, an organizational unit, a location, and an employee demographic attribute.

19. The non-transitory computer-readable storage medium of claim 14, wherein the instructions further cause the computing system to generate a visualization comprising a distribution of emotional sentiment values across multiple workplace groups.

20. The non-transitory computer-readable storage medium of claim 14, wherein the instructions further cause the computing system to:
display user comments grouped by their associated verified emotional sentiment; and
track and display changes in verified emotional sentiment over time for individual users or defined organizational groups.
